(19) United States
(12) Patent Application Publication
(10) Pub. No.: US 2018/0346731 A1
(43) Pub. Date: Dec. 6, 2018

(54) Formation of Stable Pyranoanthocyanins, and Uses Thereof as Sources of Natural Color

(71) Applicant: Ohio State Innovation Foundation, Columbus, OH (US)

(72) Inventors: Jacob Farr, Columbus, OH (US); M. Monica Giusti, Columbus, OH (US)

(73) Assignee: Ohio State Innovation Foundation, Columbus, OH (US)

(21) Appl. No.: 16/001,099

(22) Filed: Jun. 6, 2018

Related U.S. Application Data
(60) Provisional application No. 62/515,685, filed on Jun. 6, 2017.

(51) Int. Cl. C09B 57/00

(52) U.S. Cl. CPC C09B 57/00

(57) ABSTRACT

Described herein are chromophore compounds formed by interaction of ascorbic acid (AA) and a pyranoanthocyanin (PACN) compound. Also described herein are natural food colorant compositions that include chromophore compounds. The pyranoanthocyanins can be formed by the heterocyclic addition of the C4 and 5-OH of an anthocyanin, using a polar metabolite. Also described herein are pyranoanthocyanins, and methods of making and using the same.

### CROSS-REFERENCE TO RELATED APPLICATIONS

This application claims the priority to U.S. Provisional Application No. 62/515,685, filed under U.S.C. § 111(b) on Jun. 6, 2017, the entire disclosure of which is expressly incorporated herein by reference for all purposes.

### STATEMENT REGARDING FEDERALLY SPONSORED RESEARCH

This invention was made with no government support, and the government has no rights in the invention.

### BACKGROUND

There is increasing interest in the food industry to replace synthetic materials for coloring foods with natural colorants.

Consumers commonly use color to make assessments on acceptance and liking, implied flavor, safety, and overall quality of food products. Synthetic colorants have been used to correct for natural variation of food items, mask imperfections, as well as offer alternative product identities. The innate stability of synthetic colorants over natural pigments has been a driver for their selection in coloring food products. Recently, this trend has begun to reverse, as consumers have expressed concerns over the safety of synthetic colorants and preference for colorants from natural sources. Anthocyanins are viewed as a natural alternative due to their wide spectrum of hue expression. However, their application has been limited due to stability.

Anthocyanins (ACN) are a class of water-soluble polyphenols found in various fruits and vegetables. Their color properties are greatly influenced by the substitution patterns on the aglycone structure as well as pH environment. Warm hues including reds are observed at low pH but shift expression to vibrant purple-blues in more alkaline conditions. Their stability is influenced by many factors including pH, heat, enzymes, light, as well as food ingredients including vitamin C (or ascorbic acid, AA). The latter is of significance for beverages and juices, which are often fortified with high levels of this micronutrient.

The presence of AA in anthocyanin-colored solutions results in loss of color. The interaction between anthocyanins and ascorbic acid is believed to result in mutual destruction of both the pigment and micronutrient and is evident for both major vitamers, ascorbic and dehydroascorbic acid. It is reported that this is the result of condensation at carbon-4 of anthocyanins. Ascorbic acid is an electrophilic compound thought to attack the same nucleophilic sites of the anthocyanin as bisulfites and hydrogen peroxide, other bleaching agents. This presents a major hurdle for the food industry to use ACN-based colorants in juices and beverages fortified with AA.

There is no admission that the background art disclosed in this section legally constitutes prior art.

### SUMMARY OF THE INVENTION

In a first broad aspect, described herein is a natural food colorant composition where pyranoanthocyanins, with a covalently occupied C4, results in less bleaching and better preserved color expression in the presence of ascorbic acid (AA) as compared to anthocyanins (ACN).

In one embodiment, pyranoanthocyanins (PACN), having a fourth-ring covalently occupying C4, are synthesized by combining an anthocyanin with a small polar metabolite.

Described herein is a chromophore compound formed by interaction of ascorbic acid (AA) and a pyranoanthocyanin (PACN) compound at either the A, B, or D rings of the PACN compound. Without wishing to be bound by theory, it is believed that the closed C-ring of the PACN compound is maintained. In certain embodiments, the λₘₐₓ of the chromophore is different from the λₘₐₓ of the PACN compound. In certain embodiments, the chromophore is resistant to bleaching. In certain embodiments, the PACN compound is formed by heterocyclic addition of C4 and 5-OH of an anthocyanin with a polar carboxyl-containing compound. In particular embodiments, the anthocyanin is extracted from one or more of: chokeberries, blackberries, black carrot, grapes, aged wines, red cabbage, mulberries, red onions, or strawberries. In particular embodiments, the anthocyanin has Formula I:

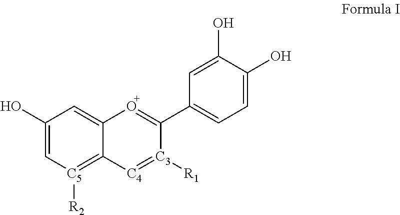

wherein R₁ is selected from the group consisting of arabinose, galactose, glucose, xylosyl(1 →2)galactoside, glucosyl(1→2)glucoside, rhamnosyl(1→6)glucoside, glucosyl(1→6)galactoside, and xylosyl(1→2)glucosyl(1→6)galactoside; and R₂ is OH. In particular embodiments, the anthocyanin comprises a sugar with a 1→6 or 1→2 glycosyl linkage.

In one embodiment, the chromophore compound is formed by interaction of ascorbic acid (AA) with a pyranoanthocyanin (PACN) compound at the D ring.

Also described is a PACN-AA chromophore compound where the λₘₐₓ is the chromophore compound is different from the λₘₐₓ of the original pyranoanthocyanin (PACN) compound.

Also described is a PACN-AA chromophore compound which experiences a hypsochromic shift as compared to the PACN compound in the absence of AA.

Also described herein is natural food colorant composition that is resistant to bleaching, comprising a chromophore compound that formed between ascorbic acid and a pyranoanthocyanin that maintains color expression.

Also described herein is natural food colorant composition, comprising a pyranoanthocyanin formed from heterocyclic addition of the C4 and 5-OH of an anthocyanin, using a small polar carboxyl compound, typically, though not necessarily, resulting from yeast metabolism.

Also described is a method of preparing a pyranoanthocyanin, the method comprising reacting an anthocyanin with a polar carboxyl-containing compound to achieve heterocyclic addition of the polar carboxyl-containing compound with the C4 and 5-OH of the anthocyanin to produce a pyranoanthocyanin. In certain embodiments, the polar carboxyl-containing compound comprises pyruvic acid, acetaldehyde, or a catechin.

In certain embodiments, the anthocyanin has Formula I:

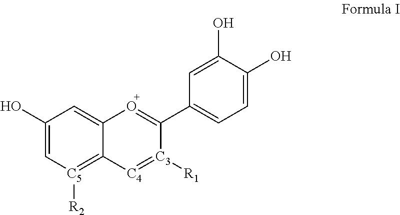

wherein: R₁ is selected from the group consisting of arabinose, galactose, glucose, xylosyl(1→2)galactoside, glucosyl(1→2)glucoside, rhamnosyl(1→6)glucoside, glucosyl(1→6)galactoside, and xylosyl(1→2)glucosyl(1→6)galactoside; and R₂ is OH.

In certain embodiments, the anthocyanin has the following structural formula Ia:

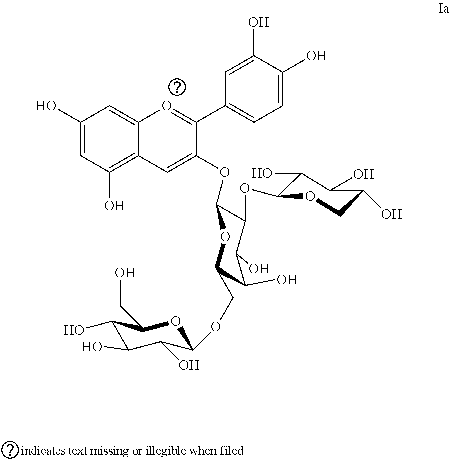

In certain embodiments, the anthocyanin has the following structural formula Ib:

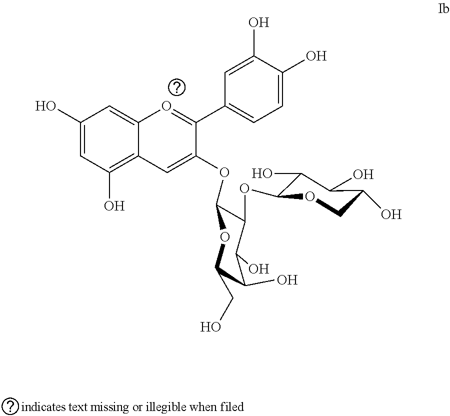

In certain embodiments, the anthocyanin has the following structural formula Ic:

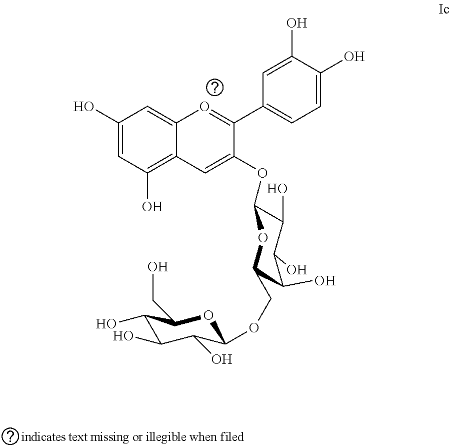

In certain embodiments, the anthocyanin has the following structural formula Id:

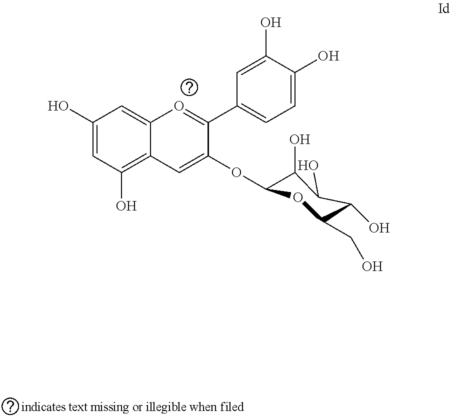

In certain embodiments, the anthocyanin has the following structural formula Ie:

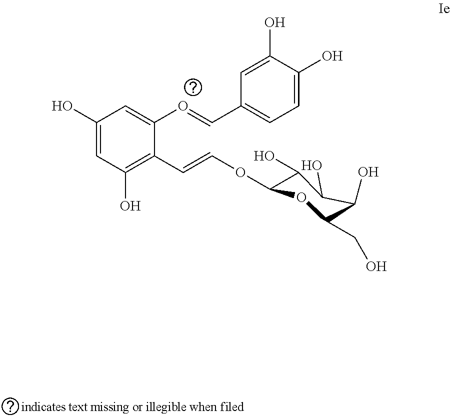

In certain embodiments, the anthocyanin comprise one or more of a cyanidin, a pelargonidin, or a malvidin.

In certain embodiments, the anthocyanin is extracted from one or more of: chokeberries, blackberries, black carrot, grapes, wines, red onions, red cabbage, mulberries, or strawberries. In particular embodiments, the method comprises washing chokeberry powder with acidified water to remove sugars and acids, washing the acidified water with ethyl acetate to remove non-polar phenolics, recovering pigments with acidified methanol, removing solvent to purify a chokeberry extract, and reacting the purified chokeberry extract with pyruvic acid.

In certain embodiments, the pyranoanthocyanin comprises one or more of: 5-carboxypyranomalvidin-3-glucoside, Pyranomalvidin-3-glucoside, Carboxypyranopelargonidin-3-glucoside, 3-O-f-glucopyranoside and 3-O-(6″-O-malonyl-f-glucopyranoside), 5-carboxypyranocyanidin-3-glucoside, 5-carboxypyranocyanidin-3-galactoside, 5-carboxypyranocyanidin-3-(glucosyl)galactoside, 5-carboxypyranocyanidin-3-(xylosyl)galactoside, or 5-carboxypyranocyanidin-3-xylosyl(glucosyl)galactoside.

Also described is a natural colorant composition comprises a pyranoanthocyanin formed from the method described herein. In certain embodiments, the natural colorant composition exhibits color stability for greater than about 14 days. Also described is a food product comprising the natural colorant composition.

Also described herein is method of preparing a natural colorant composition, comprising a compound that maintains color expression and a chromophore by combining ascorbic acid (AA) with a pyranoanthocyanin (PACN).

Also described herein is method of preparing a natural colorant composition, comprising: forming a pyranoanthocyanin by the heterocyclic addition of the C4 and 5-OH of an anthocyanin, using a polar metabolite; and, combining the pyranoanthocyanin with ascorbic acid (AA).

In certain embodiments, the pyranoanthocyanin is formed by the heterocyclic addition of the C4 and 5-OH of an anthocyanin.

In certain embodiments, the anthocyanin comprise one or more of cyanidins, pelargonidins, and malvidins.

In certain embodiments, the pyranoanthocyanin are extracted from one or more of: chokeberries, blackberries, black carrot, grapes, wines, red cabbage, mulberries, red onions, and strawberries.

In certain embodiments, the pyranoanthocyanin comprise one or more of: 5-carboxypyranomalvidin-3-glucoside, Pyranomalvidin-3-glucoside, Carboxypyranopelargonidin-3-glucoside, 3-O-β-glucopyranoside and 3-O-(6″-O-malonyl-(3-glucopyranoside), 5-carboxypyranocyanidin-3-glucoside, 5-carboxypyranocyanidin-3-galactoside, 5-carboxypyranocyanidin-3-(glucosyl)galactoside, 5-carboxypyranocyanidin-3-(xylosyl)galactoside, and 5-carboxypyranocyanidin-3-xylosyl(glucosyl)galactoside.

Also described herein is a method for forming a pyranoanthocyanin from heterocyclic addition of the C4 and 5-OH of an anthocyanin, using a polar metabolite. In certain embodiments, the polar metabolite comprises a polar carboxyl-containing compound. In certain embodiments, the polar carboxyl-containing compound comprises one or more of: pyruvic acid, acetaldehyde, and catechins. In one embodiment, the anthocyanin is cyanidin, and the polar metabolite is pyruvic acid.

Also described herein is food product, comprising a natural colorant composition containing at least one of the chromophore compounds described herein.

Also described herein is an edible product comprising the natural food colorant containing at least one of the chromophore compounds described herein.

Also described herein is product comprising the natural food colorant as described herein, and a food item, a drug or nutraceutical product, or cosmetic product.

Also described is a composition comprising Formula II:

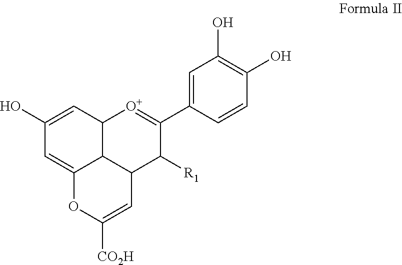

wherein R₁ is selected from the group consisting of xylosyl(1→2)galactoside, glucosyl(1→2)glucoside, rhamnosyl(1→6)glucoside, glucosyl(1→6)galactoside, and xylosyl(1→2)glucosyl(1→6)galactoside. Further provided are salts, stereoisomers, racemates, hydrates, and polymorphs of Formula II.

Various objects and advantages of this invention will become apparent to those skilled in the art from the following detailed description of the preferred embodiment, when read in light of the accompanying drawings.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1A: Formation of pyranoanthocyanin from cyanidin and pyruvic acid by heterocyclic addition.

FIG. 1B: Chemical structures of representative anthocyanins that can (right) and cannot (left) form pyranoanthocyanins. The illustration shows different cyanidin-glycosides; however, other anthocyanins (pelargonidin, malvidin, and others) also behave similarly.

FIG. 2A: Spectral absorbance changes in response to 500 mg/L AA for chokeberry, cyanidin-3-galactoside, and 5-carboxypyranocyanidin-3-galactoside over a 48 hour period including changes in λₘₐₓ.

FIG. 2B: Reaction rates of 5-carboxypyranocyanidin-3-galactoside, cyaniding-3-galactoside, and chokeberry plotted against ascorbic acid level (0-1000 mg/L). Calculations are based on the changes in absorbance at the λᵥᵢₛ₋ₘₐₓ of the solution over time.

FIG. 3: Colorimetric changes (CIEL*c*h*) of chokeberry, cyanidin-3-galactoside, and 5-carboxypyranocyanidin-3-galactoside from day 0 to day 5 for all AA levels over time. Error bars represent standard deviation.

FIG. 4: HPLC profiles for 5-carboxypyranocyanidin-3-galactoside, cyanidin-3-galactoside, and chokeberry on day 0 and 1 (470-520 nm) for 1000 mg/L AA added. MS/MS transition reported for the newly formed peaks resulting between 5-Carboxypyranocyanidin-3-galactoside and ascorbic acid interaction.

FIGS. 5A-5C: Photographs of the color changes for 5-carboxypyranocyanidin-3-galactoside (FIG. 5A), cyanidin-3-galactoside (FIG. 5B), and chokeberry (FIG. 5C) on day 0 and day 4.

FIG. 6: HPLC profile for 5-carboxypyranocyanidin-3-galactoside, showing New Peak #1 at 486 nm, New Peak #2 at 486 nm, and New Peak #3 at 478 nm.

FIG. 7: Flow chart showing one example of a pyranoanthocyanin synthesis.

FIG. 8: Flow chart showing one example of a process for juice preparation.

FIG. 9: Anthocyanin and pyranoanthocyanin aglycone structure along with sugar substitutions of selected cyanidin isolates. #→# shows glycosidic linkage of substitutions. Φ and Ψ angles are shown exemplifying rotation of 1→2 glycosidic bonds and added ω rotation in 1→6 glycosidic bonds. ^{a}m/z data from Q3 Scan of MSMS, cyanidin (287 m/z) and carboxypyranoanthocyanidin aglycone (355 m/z) found for all isolates and newly formed pyranoanthocyanins. Formed pyranoanthocyanin parent m/z was +68 by addition of fourth ring from the anthocyanin Q3 scan. ^{b}Purity described as A.U.C. (260-700 nm) of isolate peaks to profile.

FIG. 10: Pyranoanthocyanin yield for anthocyanins (500 μM) subjected to pyruvic acid treatment (×100 M ratio) and anthocyanin survival of control treatments at pH 2.5 acidified water at day 7, 14, and 31. Yield defined as (AUC₅₀₀₋₅₂₀ nm of PACN at tn/AUC_{500-520 nm} of ACN @t₀)*100. Survival defined as (AUC₅₀₀₋₅₂₀ nm of ACN at tn/AUC500-520 nm of ACN @ t₀)*100. Values shown are means (n=3) and bars represent standard deviation.

FIG. 11: Pyranoanthocyanin formation over time as monitored by HPLC. Anthocyanin (ACN) and pyranoanthocyanin (PACN) peaks are labeled. #→# shows glycosidic bond of each substitution of C3 for anthocyanin. *Cy3rut at day 14 and 31 were run under alternative HPLC conditions.

FIG. 12: Changes in spectral characteristics of anthocyanin isolates (500 μM) treated with pyruvic acid (×100 M ratio) in pH 2.5 acidified water, stored over a 31 day period at 25° C. Values shown are means (n=3) and standard deviation are presented as error bars or in parenthesis.

FIG. 13: Representative UV-Vis absorbance spectra (absorbance standardized at respective λₘₐₓ) of an anthocyanin and pyranoanthocyanin (cy3xylglugal and carboxycy3xylglugal), λₘₐₓ (nm), and color characteristics (CIEL*c*h*) of isolated anthocyanins and their respective pyranoanthocyanins obtained from HPLC-PDA detector.

FIG. 14: Color parameters for CIE lightness, chroma, and hue angle for anthocyanins (500 μM) subjected to pyruvic acid treatment (×100 M ratio) in pH 2.5 acidified water after 31 days of storage at 25° C. Values shown are means (n=3) and standard deviation are presented as error bars or in parenthesis.

### DETAILED DESCRIPTION

Throughout this disclosure, various publications, patents and published patent specifications are referenced by an identifying citation. The disclosures of these publications, patents and published patent specifications are hereby incorporated by reference into the present disclosure to more fully describe the state of the art to which this invention pertains.

The terms used in this specification generally have their ordinary meanings in the art, within the context of this invention and in the specific context where each term is used. Certain terms are discussed below, or elsewhere in the specification, to provide additional guidance to the practitioner in describing the compositions and methods of the invention and how to make and use them.

As used herein, the use of the word “a” or “an” when used in conjunction with the term “comprising” in the claims and/or the specification may mean “one,” but it is also consistent with the meaning of “one or more,” “at least one,” and “one or more than one.” Still further, the terms “having,” “including,” “containing”, and “comprising” are interchangeable and one of skill in the art is cognizant that these terms are open ended terms.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art.

As used herein, the term “colorant” refers to any substance that imparts color by absorbing or scattering light at different wavelengths.

As used herein, the term “colorant composition” refers to any composition that imparts color by absorbing or scattering light at different wavelengths.

As used herein, the term “natural colorant” refers to any substance that exists in or is produced by nature or is obtained from a natural source.

As used herein, the term “natural colorant composition” refers to any composition that comprises a colorant that exists in or is produced by nature or is obtained from a natural source.

As used herein, the term “blue colorant” refers to a colorant that reflects light at wavelengths in the region of 450 to 495 nanometers and has a maximum UV/VIS wavelength absorbance ranging from 615 to 635 nanometers.

As used herein, the term “blue colorant composition” refers to a colorant composition that reflects light at wavelengths in the region of 450 to 495 nanometers and has a maximum UV/VIS wavelength absorbance ranging from 615 to 635 nanometers.

As used herein, “λₘₐₓ” refers to the wavelength in nanometers at which the maximum fraction of light is absorbed by a substance, colorant, and/or colorant composition.

As used herein, “FD&C Blue No. 1” includes the various names given to the identical synthetic blue colorant, Brilliant Blue FCF and European Commission E133. The λₘₐₓ of FD&C Blue No. 1 is 630 nm.

As used interchangeably herein, the terms “color” and “color characteristics” refer to the color properties such as hue, chroma, purity, saturation, intensity, vividness, value, lightness, brightness, and darkness, and color model system parameters used to describe these properties, such as Commission Internationale de l'Eclairage CIE 1976 CIELAB color space L*a*b* values and CIELCH color space L*C*h° values. The CIELAB and CIELCH color models provide more perceptually uniform color spaces than earlier color models. In certain embodiments, the colorant compositions of the present disclosure can be analyzed with a spectrophotometer, and CIELAB L*a*b* and CIELCH L*C*h° values can be calculated from the spectral data. The L*a*b* and L*C*h° values provide a means of representing color characteristics and assessing the magnitude of difference between two colors.

As used herein, “hue” or “hue angle” refers to the color property that gives a color its name, for example, red, blue, and violet.

As used herein, “chroma” is a color property indicating the purity of a color. In certain embodiments, a higher chroma is associated with greater purity of hue and less dilution by white, gray, or black.

As used herein, “value” is a color property indicating the lightness or darkness of a color wherein a higher “value” is associated with greater lightness.

As used herein “admixing,” for example, “admixing a colorant composition of the present disclosure with a food product,” refers to the method where a colorant composition of the present disclosure is mixed with or added to the completed product or mixed with some or all of the components of the product during product formation or some combination of these steps. When used in the context of admixing the term “product” refers to the product or any of its components. Admixing can include a process that includes adding the colorant composition to the product, spraying the colorant composition on the product, coating the colorant composition on the product, painting the colorant composition on the product, pasting the colorant composition on the product, encapsulating the product with the colorant composition, mixing the colorant composition with the product or any combination thereof. The colorant compositions, e.g., those that are admixed with the product, can be a liquid, dry powder, spray, paste, suspension, or any combination thereof.

As used herein, “food grade,” refers to any substance that is of a grade acceptable for use in edible food products, not restricted to GRAS certification or deemed a food additive.

As used herein, “food product” refers to an ingestible product, such as, but not limited to, human food, animal foods, and pharmaceutical compositions.

In certain embodiments, the one or more pyranoanthocyanins comprise about 1% to about 100% by weight of the total colorant composition. In certain embodiments, the one or more pyranoanthocyanins comprise about 10% to about 90% by coloring capacity of the colorant composition. In certain embodiments, the one or more pyranoanthocyanins comprise about 20% to about 80% by coloring capacity of the colorant composition. In certain embodiments, the one or more pyranoanthocyanins comprise about 30% to about 70% by weight of the colorant composition. In certain embodiments, the one or more pyranoanthocyanins comprise about 40% to about 60% by coloring capacity of the colorant composition. In certain embodiments, the one or more pyranoanthocyanins comprise about 1% to about 32%, about 5% to about 15%, or about 8% to about 12% by coloring capacity of the colorant composition. In certain embodiments, the one or more pyranoanthocyanins comprise about 10% by coloring capacity of the total colorant composition.

In certain embodiments, the colorant compositions of the present disclosure exhibit increased color stability, e.g., increased red, blue and/or purple color stability.

In certain embodiments, a colorant composition of the present disclosure in solution exhibits color stability, e.g., color stability, for a time period greater than about 1 day, greater than about 2 days, greater than about 3 days, greater than about 4 days, greater than about 5 days, greater than about 6 days, greater than about 7 days, greater than about 8 days, greater than about 9 days, greater than about 10 days, greater than about 11 days, greater than about 12 days, greater than about 13 days, greater than about 14 days, greater than about 15 days, greater than about 16 days, greater than about 17 days, greater than about 18 days, greater than about 19 days, greater than about 20 days, greater than about 21 days, greater than about 22 days, greater than about 23 days, greater than about 24 days, greater than about 25 days, greater than about 26 days, greater than about 27 days, or greater than about 28 days.

Color Characteristics

As embodied herein, color characteristics of the presently disclosed colorant compositions, e.g., blue colorant compositions, can be determined. Such color characteristics can include hue, chroma, purity, saturation, intensity, vividness, value, lightness, brightness, and darkness, and color model system parameters used to describe these properties, such as Commission Internationale de l'Eclairage CIE 1976 CIELAB color space L*a*b* values and CIELCH color space L*C*h° values. For example, L*a*b* values consist of a set of coordinate values defined in a three-dimensional Cartesian coordinate system. L* is the value, or lightness, coordinate. L* provides a scale of lightness from black (0 L* units) to white (100 L* units) on a vertical axis, a* and b* are coordinates related to both hue and chroma, a* provides a scale for greenness (−a* units) to redness (+a* units), with neutral at the center point (0 a* units), on a horizontal axis; b* provides a scale for blueness (−b* units) to yellowness (+b* units), with neutral at the center point (0 b* units), on a second horizontal axis perpendicular to the first horizontal axis. The three axes cross where L* has a value of 50 and a* and b* are both zero.

L*C*h° values consist of a set of coordinate values defined in a three-dimensional semi-cylindrical coordinate system. L* is the value, or lightness, coordinate. L* provides a scale of lightness from black (0 L* units) to white (100 L* units) on a longitudinal axis. h° is the hue coordinate. h° is specified as an angle from 0° to 360° moving counterclockwise around the L* axis. Pure red has a hue angle of 0°, pure yellow has a hue angle of 90°, pure green has a hue angle of 180°, and pure blue has a hue angle of 270°. The C* coordinate represents chroma and is specified as a radial distance from the L* axis. C* provides a scale from achromatic, i.e., neutral white, gray, or black, at the L* axis (0 C* units) to greater purity of hue as the coordinate moves away from the L* axis (up to 100 or more C* units).

Synthesis of Pyranoanthocyanins

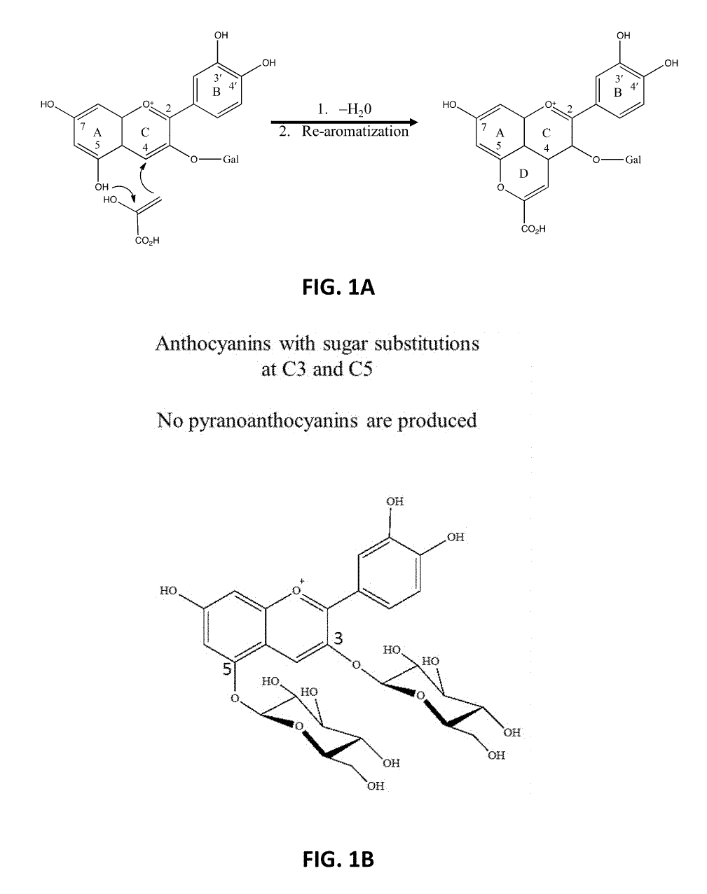

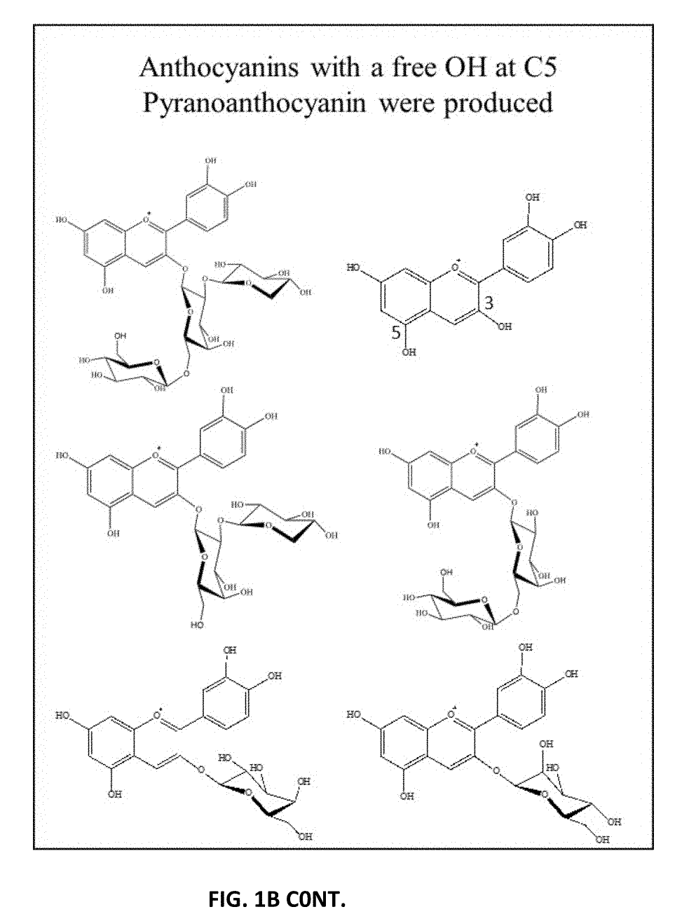

Pyranoanthocyanins (FIG. 1) are formed by anthocyanins undergoing heterocyclic addition of a polar carboxyl-containing compound such as pyruvic acid, acetaldehyde, or catechins, which are often byproducts from yeast fermentation. This results in the formation of a fourth ring (D) that covalently occupies C4 and C5 of the pigment. Thus, unlike anthocyanins, pyranoanthocyanins have a C4 that is unavailable for bleaching by AA. Pyranoanthocyanins were first reported in red wines in the 1990s, where the common chemical names vitisin A and B were assigned to the four-ringed pigments. Polymeric forms have been further discovered originating in red wines, and trace amounts have been reported naturally present in red onion and strawberries.

One of the co-inventors herein has previously invented a high-purity fractionation process for obtaining anthocyanins from fruits and vegetables, Giusti, et al., U.S. Pat. No. 8,575,334, the entire disclosure of which is expressly incorporated herein by reference for all purposes. Further, such co-inventor has previously invented a method of isolating blue anthocyanin fractions, Robbins, et al., U.S. Pat. No. 9,598,581, along with natural blue anthocyanin-containing colorants, Robbins, et al., US Pub. No. 2016/0015067, and colorant compositions and methods of use, Robbins, et al., US Pub. No. 2017/0000169, the entire disclosures of which are expressly incorporated herein by reference for all purposes.

Table 1 below contains commonly known pyranoanthocyanins.

TABLE 1
Examples of Pyranoanthocyanins

| Common | | |
|---|---|---|
| Name | Chemical Name | Source |
| Vitisin A | 5-carboxypyranomalvidin-3-glucoside | Grape |
| Vitisin B | Pyranomalvidin-3-glucoside | Grape |
| N.A. | Carboxypyranopelargonidin-3-glucoside | Strawberry |
| N.A. | 3-O-β-glucopyranoside and | Red Onion |
| | 3-O-(6″-O-malonyl-β-glucopyranoside) | |

Table 2 below lists non-limiting examples of pyranoanthocyanins successfully synthesized by the inventors

TABLE 2
Pyranoanthocyanins synthesized

| Common | | |
|---|---|---|
| Name | Chemical Name | Source |
| N.A. | 5-carboxypyranocyanidin-3-glucoside | Blackberry |
| N.A. | 5-carboxypyranocyanidin-3-galactoside | Chokeberry |
| N.A. | 5-carboxypyranocyanidin- | Black Carrot |
| | 3-(glucosyl)galactoside | |
| N.A. | 5-carboxypyranocyanidin- | Black Carrot |
| | 3-(xylosyl)galactoside | |
| N.A. | 5-carboxypyranocyanidin- | Black Carrot |
| | 3-xylosyl(glucosyl)galactoside | |

From this synthesis work, structural features that are necessary for pyranoanthocyanin formation have been uncovered. Specifically, a free hydroxyl on 5-OH is essential for synthesis. The majority of anthocyanins in the diet have sugars attached to the C3 position and have a free hydroxyl group at C5. However, anthocyanins having sugars attached to both C3 and C5 are also found in the diet, such as the pigments in red cabbage, red radish, and purple potato. In FIG. 1B, the structural differences are illustrated for non-limiting example pigments that are validated for pyranoanthocyanin formation.

Anthocyanins containing different types and numbers of sugar attachments on C3 have been investigated for synthesis. All formed pyranoanthocyanins at high yields (>90%) under accelerated conditions. However, additional sugar moieties do slow the reaction. Three different aglycone structures (cyanidin, malvidin, and pelargonidin) are listed above in Tables 1 and 2, indicating the limited role of B-ring substitutions in pyranoanthocyanin formation. The grape and red onion sources also contain acylated (addition of acid) anthocyanins, which shows pyranoanthocyanin synthesis is possible in the presence of these bound acids.

Synthesis of PACN-AA Chromophore Compounds

New chromophore compounds are formed by interaction of ascorbic acid (AA) with a PACN at at least one of the A, B, and D rings and the believed maintenance of a closed C-ring (FIG. 1A). In particular, the new chromophore compounds are formed by an interaction with the D-ring of a PACN and ascorbic acid. Such interaction results in a “degradation” chromophore PACN-AA compound (where the “degradation” chromophore PACN-AA compound is generally defined as a compound having a hypochromic and/or hypsochromic shift).

Glycosylated Pryanoanthocyanins

Pyranoanthocyanins having Formula II have further been synthesized:

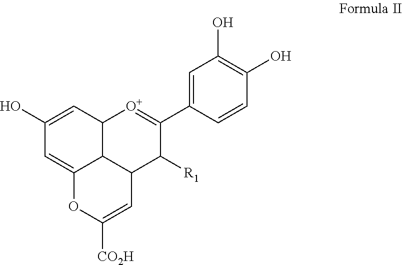

where R₁ is selected from the group consisting of xylosyl(1→2)galactoside, glucosyl(1→2)glucoside, rhamnosyl(1→6)glucoside, glucosyl(1→6)galactoside, xylosyl(1→2)glucosyl(1→6)galactoside, arabinose, galactose, and glucose. Thus, provided herein are compositions comprising Formula II, as well as salts, stereoisomers, racemates, hydrates, and polymorphs of Formula II.

Kits

The compositions disclosed herein may also be made available via a kit containing one or more key components. A non-limiting example of such a kit comprises an anthocyanin in one container, and a polar carboxylate-containing compounds in another container, where the containers may or may not be present in a combined configuration. Many other kits are possible, such as kits further comprising ascorbic acid. The kits typically further include instructions for using the components of the kit to practice the subject methods. The instructions for practicing the subject methods are generally recorded on a suitable recording medium. For example, the instructions may be present in the kits as a package insert or in the labeling of the container of the kit or components thereof. In other embodiments, the instructions are present as an electronic storage data file present on a suitable computer readable storage medium, such as a CD-ROM or flash drive. In other embodiments, the actual instructions are not present in the kit, but means for obtaining the instructions from a remote source, such as via the internet, are provided. An example of this embodiment is a kit that includes a web address where the instructions can be viewed and/or from which the instructions can be downloaded. As with the instructions, this means for obtaining the instructions is recorded on a suitable substrate.

### EXAMPLES

Certain embodiments of the present invention are defined in the Examples herein. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions.

### Example I—Interaction of Ascorbic Acid with Anthocyanins and Pyranoanthocyanins

Materials

Powdered chokeberry fruit was provided by Artemis Inc. (Fort Wayne, Ind., U.S.). Lab grade pyruvic acid used for the synthesis of pyranoanthocyanins was purchased from Sigma Aldrich (St. Louis, Mo., U.S.). USP grade 3% hydrogen peroxide was manufactured by Kroger (Cincinnati, Ohio, U.S.). Analytical grade ascorbic acid (99% L-ascorbic acid) was purchased from Sigma Aldrich (St. Louis, Mo., U.S.). HPLC grade acetonitrile and water were obtained from Fisher Scientific (Hampton, N.H., U.S.), and HPLC grade formic acid was obtained from Sigma Aldrich (St. Louis, Mo., U.S.).

Anthocyanin Semi-Purification (SPE)

Chokeberry powder was mixed with water acidified with 0.01% HCl prior to purification. The solution was loaded onto a Waters Sep-pak C18 cartridge for solid phase extraction (SPE). The column was then washed with acidified water (0.01% HCl) to remove of sugars and acids then followed with ethyl acetate for removal of the more non-polar phenolics. Pigments were recovered from the cartridge with methanol acidified with 0.01% HCl, and the solvent was removed by rotary evaporation (40° C., under vaccuum). Pigments were then solubilized and stored in acidified water for future use. This was the only preparatory step for chokeberry treatments.

Pyranoanthocyanin Synthesis

Pyrananthocyanins were synthesized from the semi-purified chokeberry by addition of pyruvic acid. The extract (1000 gtM cyanidin-3-glucoside equivalent) was added to a pH 2.6 citrate buffer that had 0.1% potassium sorbate and 0.1% sodium benzoate to prevent molding. A molar ratio of 1:50 (ACN: pyruvic acid) was followed. The prepared anthocyanin pyruvic acid solution was stored in an incubator in the dark at 35° C. for 10 days (Isotemp, Fisher Scientific, Waltham, Mass., US). After the incubation period ended, cyanidin-3-galactoside, and 5-carboxypyranocyanidin-3-galactoside, the resulting pyranoanthocyanin from cyanidin-3-galactoside and pyruvic acid, were isolated from the solution using semipreperatory HPLC.

Anthocyanin and Pyranoanthocyanin Purification

A reverse phase HPLC system composed of the following modules was used: LC-6AD pumps, CBM-20A communication module, SIL-20A HT autosampler, CTO-20A column oven, and SPD-M20A Photodiode Array detector (Shimadzu, Md., U.S.). The reverse-phase column selected was a 250×21.2 mm Luna pentafluorophenyl column with 5 m particle size and 100 Å pore size (Phenomenex, Calif., U.S.). Samples were filtered prior to injection with a Phenex RC 0.45 m, 15 mm membrane syringe filter (Phenomenex, Calif., U.S.).

With a flow rate of 10 mL/min and a run time of 30 minutes, peaks were separated and collected. An isocractic system with the following solvents were used: 11:89 (Solvent A: Solvent B v/v) with solvent A being 4.5% formic acid in HPLC grade water and solvent B was HPLC grade acetonitrile. Elution of peaks was monitored at 500 nm. Peaks were manually collected. The two collected peaks were diluted with distilled water and again subjected to SPE semi-purification to remove formic acid and acetonitrile from the HPLC. Rotary evaporation was used to remove methanol, and the pigments were stored in 0.01% HCl in acidified water.

Anthocyanin and Pyranoanthocyanin Purity

Prior to experimentation, pigments were evaluated for purity by using an analytical HPLC only different from the previously listed one by the use of different pumps (LC-20AD, Shimadzu, Md., US). Purified pigments were filtered using the Phenex RC 0.45 μm membranes. A binary system with 1 mL/min flow rate was used: solvent A: 4.5% formic acid in HPLC grade water and solvent B: HPLC grade acetonitrile. The gradient began with an isocratic flow of 6% solvent B for 17 minutes (elution of primary anthocyanins), increasing to 15% solvent B by 45 minutes (elution of primary pyranoanthocyanins), and to 40% solvent B by 50 minutes. A 10 μL injection volume was loaded onto a Phenomenex Kinetix 5 μm EVO C18 100 A. 150×4.6 mm column and Phenomenex Ultra UHPLC EVO C18 guard cartridge attached.

Purity was expressed in terms of % peak area of targeted pigment as compared to the total area of all peaks present in the max plot (260-700 nm). The isolate of 5-carboxypyranocyanidin-3-galactoside accounted for 94% of the overall area under the curve (AUC), cyanidin-3-galactoside isolate was 92% AUC, while chokeberry ACN purity was 35% AUC. Chokeberry ACN likely contained other phenols present in the source material.

Sample Preparation

The semi-purified chokeberry extract, the isolated cyanidin-3-galactoside, and the purified 5-carboxypyranocyanidin-3-galactoside were diluted in pH 3.0 citrate buffer (0.1 M adjusted with HCl) until an absorbance of 1.0 at their respective λₘₐₓ was reached. Levels of AA of 250, 500, and 1000 mg/L were added using a concentrated ascorbic acid stock solution, and a control consisting of each pigment with the absence of AA was maintained. The control consisted of the pigment in the buffer in the absence of AA. An additional test was performed with the same model juice using hydrogen peroxide, a known degradation product of AA. To determine if AA bleaching was due to formation of H₂O₂, direct addition of it was investigated. In place of added AA, a 62.2 μL of a 0.3% peroxide solution was added to match the molar equivalency of the 500 mg/L AA level, which was 2.84 mM.

All samples were brought to the same final volume with additional citrate buffer. The pH of all samples were evaluted using a S220 SevenCompact pH meter (Mettler Toledo, Columbus, Ohio, U.S.) and were found to be 3.0±0.05. Samples were stored in the dark at 25° C. in an incubator. UV-Vis spectrophotometry, colorimetry, and HPLC analyses were conducted over a 5 day period following the addition of ascorbic acid or hydrogen peroxide. UV-Vis spectral data was collected every hour for the first 8 hours, and then at 12 hr, and daily from that point on for 5 days. Spectra and color were eveluated with this data. HPLC analyses were conducted on days 0, 1, 3, and 5. All treatments were run in triplicate.

UV-Vis Spectrophotometry of Samples

A SpectraMax 190 Microplate Reader (Molecular Devices, Sunnyvale, Calif., U.S.) with a 96-well plate (poly-D-lysine coated polystyrene) were used for the evaluation of absorbance from 380-700 nm, 1 nm intervals. Aliquots (200 uL) of samples were loaded into individual wells, and a blank consisted of the same citrate buffer used.

Color Analyses of Samples

Using UV-Vis spectral data (5 nm steps, 380-700 nm) in combination with software written for color conversion, absorbance data was translated to CIE-L*c*h*. The calculations for CIE-L*c*h* implemented by the software used CIE relative spectral power distribution for a D65 standard illuminants and 10° observer angle function. Color data is reported as L* (lightness), c* (chroma), and h* (hue angle).

HPLC Monitoring of Samples

Prepared solutions were monitored to determine the formation of potential degradation products or profile changes. Using the analytical HPLC system and conditions described, chromatograms were monitored with the max plot (260-700 nm), 490 nm (near λₘₐₓ of 5-carboxypyranocyanidin-3-galactoside), and 520 nm (near ma of cyanidin-3-galactoside). A max plot of 470-520 nm was later added to standardize changes in the AUC for all three pigments and their degradation products.

MS/MS Evaluation of Pigments

The newly formed structures were evaluated by triple quadrupole mass spectrometry to evaluate the interaction of ascorbic acid and pyranoanthocyanin. With the development of newly formed peaks for the pyranoanthocyanin, tandem mass spectrometry (MS/MS) was performed to obtain additional structural information on the novel structures. The same HPLC conditions and column mentioned above were used on a uHPLC (iNexera) system coupled to a tandem MS unit (LCMS 8040) (Shimadzu). Electrospray ionization was used with the following conditions: 1.5 L/min nebulizing gas flow, 230° C. desolvation line temperature, 200° C. heat block temperature, and 15 L/min drying gas flow. Two total ion scans (Q3) were performed, both in positive and negative mode from 100-1500 mass unit with an event time of 0.1 s. Based on the scan results, the following events were added (positive mode) and the sample rerun with secondary collisions in argon gas: product ion scan, 535 m/z; product ion scan, 519 m/z; product ion scan, 503 m/z; and precursor ion scan, 355 m/z. These secondary collision events all had an event time of 0.1 s and a collision energy of −35.0 eV. To also consider the possibility of condensation of the pyranoanthocyanin and ascorbic acid, the following single ion monitoring was also included: 675 m/z for 5-carboxypyranocyanidin-3-galactoside (517)+ascorbic acid (176) —H₂O (18) and 673 m/z for dehydroscorbic acid (174).

Statistical Analysis of Data

Data was organized for means and standard deviations using Microsoft Excel (Redmond, Wash., U.S.). 1-Way ANOVA was performed for each treatment at all time points to determine if a significant change in CIEL*c*h and maximum absorbance occurred as well as Tukey's post-hoc test to determine when the change became signficantly different from time 0. 1-Way ANOVA was also performed for each pigment (control, 250, 500, 1000 mg/L AA) at each time point to determine if and when which CIEL*c*h and maximum absorbance became significantly different from the control. Software used for ANOVA tests was SPSS (IBM, North Castle, N.Y., U.S.).

Results

UV-Vis Spectrophotometry

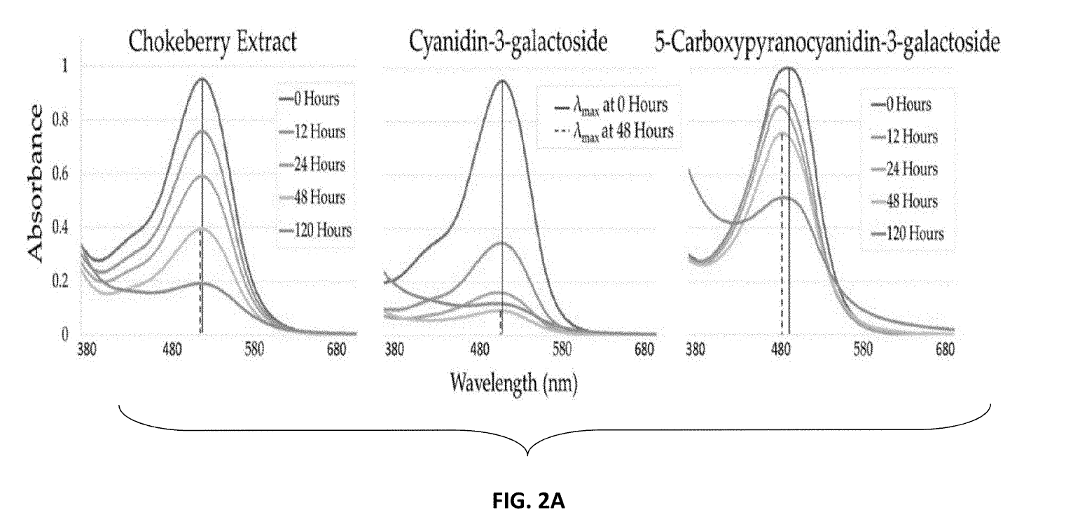

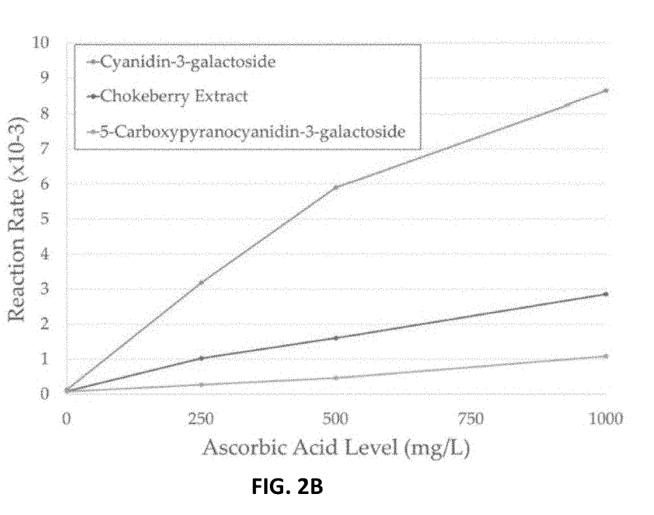

Anthocyanins degraded quickly in the presence of ascorbic acid, as seen in FIG. 2. Chokeberry extract, containing an ACN profile which is ˜79% Cyanidin-3-galactoside, and with anthocyanins representing ˜35% of the total AUC in the max plot, showed greater resistance to bleaching compared to the purified Cyanidin-3-galactoside (˜92% AUC in the max plot). Without wishing to be bound by theory, this is believed to be the result of other chokeberry phenols playing a protective role against AA-induced degradation.

PACN (5-carboxypyranocyanidin-3-galactoside), derived from cyanidin-3-galactoside, showed the least change in absorbance over time. Covalently occupying C4 in 5-carboxypyranocyanidin-3-galactoside resulted in less change in absorbance as compared to cyanidin-3-galactoside and chokeberry, consistent with other reports of bleaching observed with bisulfites.

All pigments experienced significant changes in maximum absorbance over time but post hoc analysis indicated these changes occurred at different rates. As AA levels increased, the loss in absorbance for each pigment over time also increased, revealing a dose-dependent effect of AA. The following times were necessary before a significant difference (p<0.05) in maximum absorbance from time 0 was found for each pigment at all levels of AA added: cyanidin-3-galactoside, 2 hours; chokeberry extract, 12 hours, and 5-carboxypyranocyanidin-3-galactoside, 24 hours. As AA levels increased, the loss in absorbance for each pigment over time also increased, revealing a dose-dependent effect of AA. For 500 mg/L AA treatments over a 5 day period, 5-carboxypyranocyanidin-3-galactoside saw a reduction of 38% reduction in maximum absorbance, chokeberry a 79% reduction, and cyandin-3-galactoside an 88% reduction.

Changes in λₘₐₓ were also observed. For 500 mg/L AA levels, the following hypsochromic changes in λₘₐₓ occurred: chokeberry, 512 to 511 nm; cyanidin-3-galactoside, 511 to 509 nm, 5-carboxypyranocyanidin-3-galactoside, 491 to 484 nm.

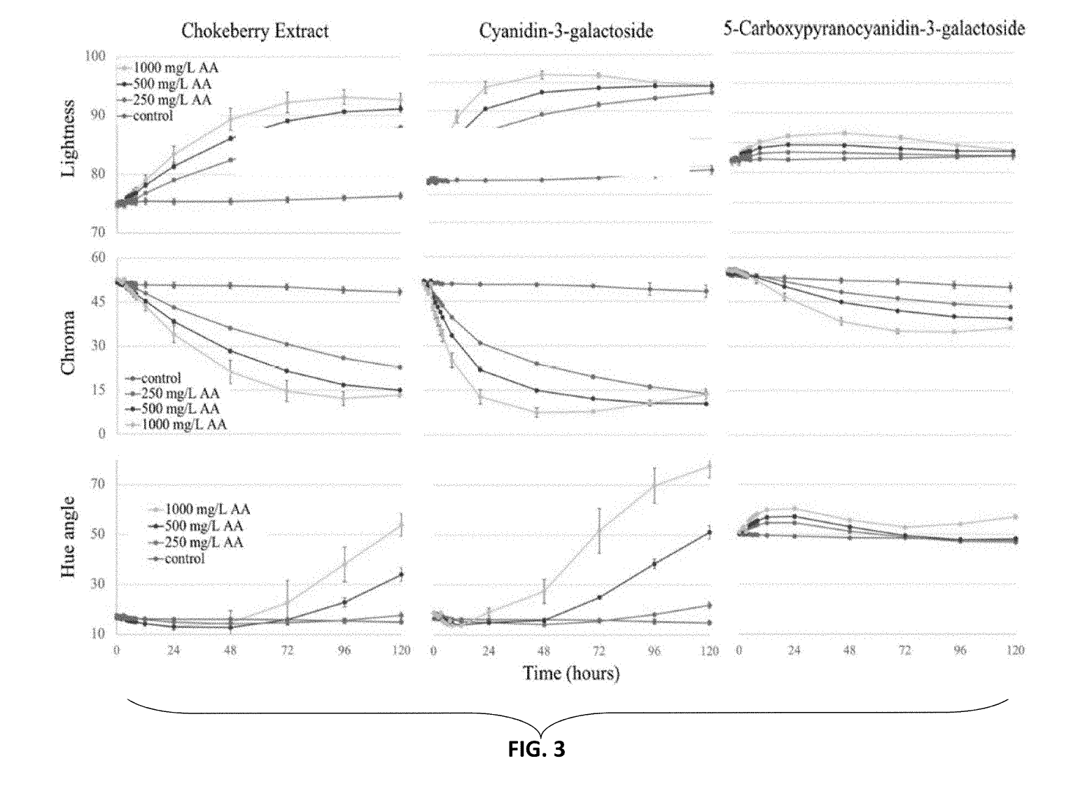

These shifts in λₘₐₓ are reflected in FIG. 3. The change for 5-carboxypyranocyanidin-3-galactoside correlated with the newly developed peaks discovered during HPLC analysis and resulted in the solution being more orange-red. Hypsochromic changes on ACN (chokeberry and cyanidin-3-galactoside) λₘₐₓ observed over the 5 days of the AA treatment, were less than 5 nm, regardless of the levels of AA. However, 5-carboxypyranocyanidin-3-galactoside experienced hypsochromic shifts as large as 10 nm, with shifts becoming more pronounced as AA levels increased.

Kinetics of Degradation

Because of the rapid nature of AA-induced color loss, degradation kinetics were evaluated in terms of change in maximum absorbance at the original λₘₐₓ over time. Bleaching is a first-order reaction, typical of ACN degradation, and was modeled as such in determining the reaction rate and half-life. The decrease in maximum absorbance correlated with an increase in lightness (L*) as well as the decrease in chroma (c*). The reduction in maximum absorbance did closely follow first-order kinetics for chokeberry extract and cyanidin-3-galactoside but slightly deviated for 5-carboxypyranocyanidin-3-galactoside. This now shows that there are different reactions taking place contributing to the change in maximum absorbance for pyranoanthocyanin-ascorbic acid interaction, but not in the case of anthocyanin-ascorbic acid interaction. The kinetics results for each pigment and AA level can be found in Table 3 below.

TABLE 3
Reaction rates and half-life (t_{1/2}) of solutions colored with
different pigments stored at 25° C. in the dark, modeled
with first-order kinetics. Calculations are based on the changes in
absorbance at the λᵥᵢₛ₋ₘₐₓ of the solution over time.

| Ascorbic | | | t_{1/2} | |
|---|---|---|---|---|
| Acid Level | Pigment | K | (hours) | R² |
| Control | Chokeberry extract | 8.08E−04 | 858 | 0.947 |
| | Cyanidin-3-galactoside | 1.27E−03 | 546 | 0.957 |
| | 5-carboxypyranocyanidin- | 7.08E−04 | 978 | 0.977 |
| | 3-galactoside | | | |
| 250 | Chokeberry extract | 1.02E−02 | 68 | 0.991 |
| mg/L AA | Cyanidin-3-galactoside | 3.18E−02 | 22 | 0.996 |
| | 5-carboxypyranocyanidin- | 2.69E−03 | 258 | 0.992 |
| | 3-galactoside | | | |
| 500 | Chokeberry extract | 1.60E−02 | 43 | 0.991 |
| mg/L AA | Cyanidin-3-galactoside | 5.90E−02 | 12 | 0.998 |
| | 5-carboxypyranocyanidin- | 4.61E−03 | 150 | 0.965 |
| | 3-galactoside | | | |
| 1000 | Chokeberry extract | 2.85E−02 | 24 | 0.999 |
| mg/L AA | Cyanidin-3-galactoside | 8.64E−02 | 8 | 0.996 |
| | 5-carboxypyranocyanidin- | 1.08E−02 | 64 | 0.998 |
| | 3-galactoside | | | |

With 1000 mg/L AA added, Cyanidin-3-galactoside had a half life of 8 hours, chokeberry extract, 24 hours, and 5-carboxypyranocyanidin-3-galactoside was 64 hours, seen in Table 3.

Without ascorbic acid, 5-carboxypyranocyanidin-3-galactoside had the greatest half life (978 hours), followed by chokeberry extract (858 hours) and then Cyanidin-3-galactoside (546 hours). Addition of ascorbic acid dramatically reduced half-lifes for all pigments. With 1000 mg/L AA added, the 5-Carboxypyranocyanidin-3-galactoside half-life was 64 h; chokeberry extract had a half-life of 24 h; and Cyanidin-3-galactoside had a half-life of 8 h, as seen in Table 3. This order of stability was also exhibited across all AA levels. The enhanced stability and extension of half life for 5-carboxypyranocyanidin-3-galactoside was more evident upon addition of ascorbic acid. Pyranoanthocyanins exhibited a half-life 8-13× higher than cyanidin-3-galactoside in the presence of AA. Kinetics data shows that C4 is an important site for anthocyanin-ascorbic acid interaction, and also shows that alternative mechanisms play a role in AA-mediated degradation for the pyranoanthocyanin.

The relationship between ascorbic acid level and the reaction rates was additionally assessed to observe how each of these pigments responds to ascorbic acid addition. A linear relationship was found and can be seen in FIG. 2B. The R2 values for these pigments at varying AA levels are the following: chokeberry extract, 0.99; Cyanidin-3-galactoside, 0.96; and 5-carboxypyranocyanidin-3-galactoside, 0.98. Linearity is lost to some degree for Cyanidin-3-galactoside with 1000 mg/L AA addition. The slope could be effectively regarded as how responsive (or deleterious) the change in pigment solution maximum absorbance is upon AA addition, with a higher slope indicating greater susceptibility to AA. The slope of Cyanidin-3-galactoside was 3.1× that of chokeberry extract and, in comparison to 5-carboxypyranocyanidin-3-galactoside, cyanidin-3-galactoside was 8.2×, and chokeberry extract 2.7× more susceptible.

Colorimetry

Lightness

Rapid color loss and extensive bleaching of pigments is shown with CIE lightness (L*) in FIG. 3. Within 48 hours exposed to 1000 mg/L AA L* increased from 77.2 to 96.4 (Δ19.2) for cyanidin-3-galactoside; chokeberry, 74.4 to 89.4 (Δ15.0); and 5-carboxypyranocyanidin-3-galactoside, 81.7 to 86.6 (Δ4.9). The presence of AA resulted in higher lightness over time, and this was dose dependant. Pyranoanthocyanins showed the least change in L* in response to AA, and cyanidin-3-galactoside the greatest. An increase in L* represents a lighter color expression and was most evident for chokeberry and cyanidin-3-galactoside.

Chroma

Pigment levels were standardized by absorbance at their respective λₘₐₓ; therefore, chroma values were in close agreement at day 0. Chroma, being a measure of color intensity, is useful for determining the extent of bleaching, and is shown in FIG. 3. The PACN had less change in chroma compared to cyanidin-3-galactoside and chokeberry. Chroma decreased with increasing AA levels with the exception of cyanidin-3-galactoside after 48 hours, believed to be the result of ascorbic acid and pigment browning playing a larger role at those times. The changes in chroma in reponse to AA addition followed: cyanidin-3-galactoside>chokeberry>5-carboxypyranocyanidin-3-galactoside. All pigments (including controls) experienced a significant change in chroma over 5 days. Post hoc analysis was used for the determination of the time necessary for a change from time 0 and showed differences. For all levels of AA, 5-carboxypyranocyanidin-3-galactoside did not experience a signficant change in chroma as compared to the control until 48 hours, for cyanidin-3-galactoside 2 hours, and chokeberry, 12 hours.

Hue Angle

Synthesis of pyranoanthocyanins results in a pigment with a lower λₘₐₓ and higher hue angle compared to the respective anthocyanin, having a more orange-red color expression, as compared to the red color of ACN. This was clearly observed on the initial hue angle values of 5-carboxypyranocyanidin-3-galactoside (50°), a more orange-red hue than Cyanidin-3-galactoside (16.6°), with a more pure red color (FIG. 3).

While the initial hue angle for chokeberry and cyandin-3-galactoside started much lower and more red (<20°) than the PACN, the reaction between ACN-AA resulted in a dramatic color shift towards a yellow coloration. For the 1000 mg/L AA level, large increases in hue angle were observed from day 0 to 5 for chokeberry (17.6° to 53.8°) and cyanidin-3-galactoside (18.7° to 77.5°) while the hue angle change was much smaller for 5-carboxypyranocyanidin-3-galactoside, changing from 51.0° to 57.1. Changes in hue angle in the presence of AA were dose dependant. The rapid increase in hue angle for cyanidin-3-galactoside and chokeberry is now believed to be the result of pigment degradation and fading; whereas, for 5-carboxypyranocyanidin-3-galactoside, which better retained original chroma and lightness parameters, new pigment formation may explan hue angle changes.

Total Color Change (ΔE)

Total color changes (ΔE) were calculated as the color change from day 0 to 5 for each respective treatment, and presented in Table 4.

Table 4 shows day 0 and 5 colorimetric values (CIEL*c*h*) and total color change (ΔE) of chokeberry, cyanidin-3-galactoside, and 5-carboxypyranocyanidin-3-galactoside for all AA levels over time. Numbers are means of 3 replications, followed by (standard deviations). ΔE: total color change from day 0 (control) to day 5.

| | | | Lightness | | Chroma | | Hue Angle | | ΔE |
|---|---|---|---|---|---|---|---|---|---|
| Treatment | | | Day 0 | Day 5 | Day 0 | Day 5 | Day 0 | Day 5 | Over 5 days |
| Chokeberry | Control | | 75.1 (0.5) | 76.3 (0.5) | 51.6 (0.8) | 48.4 (1.2) | 16.6 (0.5) | 14.9 (0.8) | 3.3 (0.4) |
| Extract | 250 | mg/L AA | 74.7 (0.2) | 88.0 (0.2) | 52.3 (.4) | 22.8 (0.3) | 174. (0.2) | 175. (0.5) | 29.9 (0.4) |
| | 500 | mg/L AA | 75/0 (0.3) | 91.1 (0.6) | 51.8 (0.6) | 15.0 (0.4) | 16.6 (0.3) | 34.0 (3.1) | 36.9 (0.2) |
| | 1000 | mg/L AA | 74.4 (0.2) | 92/7 (1.1) | 52.9 (0.2) | 13.3 (0.6) | 17.6 (0.2) | 53.8 (3.1) | 42.0 (2.2) |
| Cyanidin-3- | Control | | 77.3 (0.1) | 794. (0.8) | 51.2 (0.2) | 46.5 (2.1) | 18.6 (0.1) | 15.9 (1.0) | 2.6 (1.1) |
| galactoside | 250 | mg/L AA | 77.5 ( ).2) | 93.2 (0.3) | 50.8 (0.2) | 13.9 (0.7) | 18.7 (0.1) | 21.9 (1.2) | 19.3 (0.3) |
| | 500 | mg/L AA | 77.0 (0.1) | 94.4 (0.6) | 51.8 (0.0) | 10.5 (0.4) | 18.8 (0.0) | 51.1 (2.7) | 23.6 (0.2) |
| | 1000 | mg/L AA | 77.2 (0.3) | 94.5 (0.7) | 50.9 (0.1) | 13.7 (1.8) | 18.7 (0.1) | 77.5 (4.5) | 27.6 (0.7) |
| 5- | Control | | 82.2 (0.2) | 82.2 (0.6) | 54.3 (0.7) | 49.9 (1.3) | 50.0 (0.2) | 47.5 (0.6) | 2.1 (0.4) |
| carboxypyrano- | 250 | mg/L AA | 81.9 (0.1) | 82.8 (0.3) | 55.2 (0.4) | 43.2 (0.2) | 50.7 (0.2) | 46.9 (.3) | 4.5 (0.2) |
| cyanidin-3- | 500 | mg/L AA | 82.1(0.3) | 83.6 (0.4) | 54.7 (0.3) | 39.2 (0.3) | 50.4 (0.1) | 48.3 (0.4) | 5.0 (0.2) |
| galactoside | 1000 | mg/L AA | 81.7 (0.5) | 83.7 (0.2) | 55/6 (0.7) | 36.2 (0.3) | 51.0 (0.1) | 57.1 (0.7) | 5.2 (0.5) |

Without AA, chokeberry had the smallest ΔE, followed by 5-carboxypyranocyanidin-3-galactoside, and cyanidin-3-galactoside. Other phenolics present in chokeberry could have enhanced color retention through mechanisms such as copigmentation or radical oxidation by additional phenolics which would have not been possible with isolated 5-carboxypyranocyanidin-3-galactoside and cyanidin-3-galactoside. This is is supported by examples where quercetin quercitin-3-rhamnoside were found to lead to higher anthocyanin retention in the presence of AA.

Chokeberry fruit has 89 mg/kg of quercetin, and this is now believed to be why greater stability was observed for the chokeberry treatment as compared to purified cyanidin-3-galactoside. For all levels of AA addition, chokeberry and cyanidin-3-galactoside had a ΔE greater than 29. However, 5-carboxypyranocyanidin-3-galactoside with AA exhibited a signficiantly smaller color shift with ΔE's ranging from 8.7 to 10.9. This three-fold reduction in ΔE resulted in overall better retention of color in response to AA addition.

HPLC Evaluation

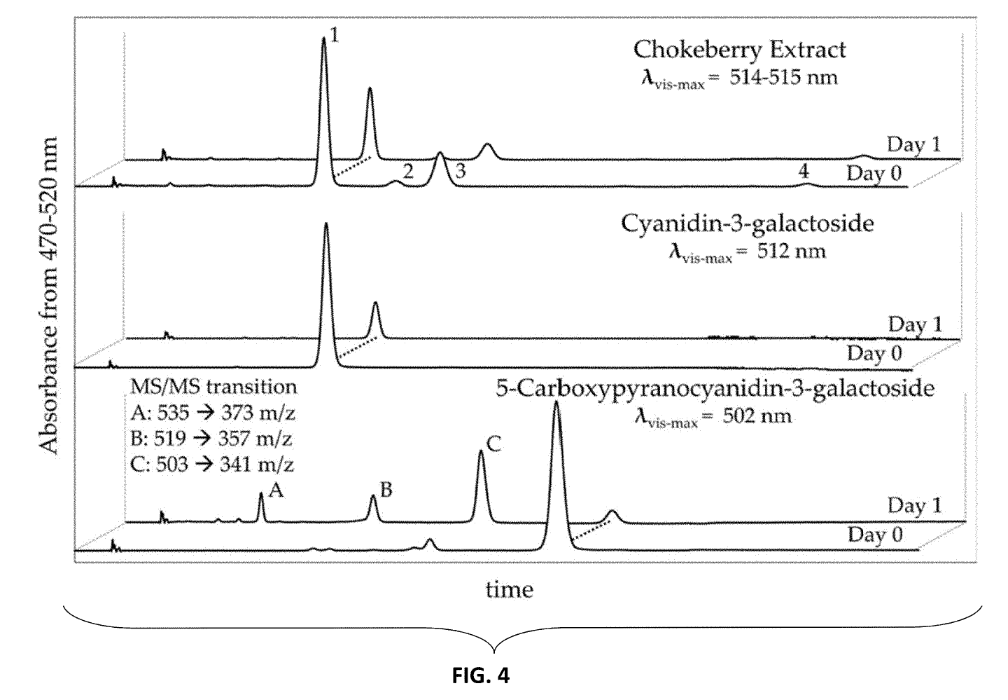

To determine the relationship between spectral and color changes with changes in pigment composition, HPLC analysis was utilized. Cyanidin-3-galactoside and the PACN 5-carboxypyranocyanidin-3-galactoside showed a dramatic reduction (2% and 10% of the target peaks left after 1 day, respectively, while less than 1% were left after 5 days for both with 1000 mg/L AA addition) over time in the presence of AA, followed by and chokeberry extract (32% left after 1 days and only 5% after 5 days for 1000 mg/L AA addition), as seen in FIG. 4.

This was in contrast to UV-Vis and colorimetric data, which could have indicated greater retention of 5-carboxypyranocyanidin-3-galactoside over chokeberry anthocyanins.

Analysis of pigments profiles revealed three newly-formed peaks containing a chromophore resulting between 5-carboxypyranocyanidin-3-galactoside and ascorbic acid. These new peaks appeared within the first 24 hours and can be seen in FIG. 4.

Anthocyanins contributed to 35% of the total AUC in the max plot (260-700 nm), mainly due to the presence of other polyphenols. The largest non-anthocyanin peak with a λᵥᵢₛ₋ₘₐₓ of 322 nm was likely chlorogenic acid, as it is reported to be present in the berry. After 1 day of exposure to 1 g/L AA, all anthocyanins in the chokeberry extract decreased by 65%. The loss of individual pigments ranged from 64-68%, revealing similar degradation kinetics for all pigments present. By day 5, only 4% of the original pigments in the chokeberry extract had survived. The behavior of Cyanidin-3-galactoside was similar to that of chokeberry extract but was thought to experience more rapid bleaching due to the absence of other polyphenols, imparting a protective effect. The isolated anthocyanin accounted for 92% of the AUC in the day 0 maxplot. By day 1, Cyanidin-3-galactoside was reduced by 91% and day 5, >99%.

For the pyranoanthocyanin, the isolated structure accounted for 94% of the AUC from the maxplot. By day 1, this peak was reduced 93% and 99% by day 5; however, unlike the anthocyanins, where the pigments degraded into colorless forms, the PACN-AA interaction resulted in the development of new peaks in the visible range, labeled A, B, and C in FIG. 4. Peak A appears to be entirely newly formed in response to AA and was not present in either the control or PACN+AA day 0 treatment. Peaks B and C were present at low levels in both the control and AA treatment at day 0 and could be colored degradation products. It appears that AA promotes the formation of these two compounds with peak B having 3.7× the AUC and peak C 15.9×AUC (470-520 nm) by day 1 as compared to the day 0 control treatment. These newly formed peaks also corroborate the spectra changes observed using the plate reader. The newly formed peaks had the following λᵥᵢₛ₋ₘₐₓ: A, 487 nm; B, 486 nm; and C, 477 nm. The formation of these new compounds aligned with both colorimetric data (increase in hue angle) and the spectral shift (hypsochromic response) that was observed with the solutions in response to AA. The formation of the new peaks is likely how the pyranoanthocyanin solution better maintained original color expression even with the rapid loss of the parent compound. The formation of three new chromophores between the PACN-AA interaction could be the result of several different phenomena, and additional experiments were performed to include MS/MS data of the new structures.

For the three peaks produced after AA addition, it is possible that these are the result of interaction with PACN at alternative sites (not C2 or C4). With the addition of a fourth ring, ascorbic acid could have reacted with the D-ring substitution (carboxylic acid group) and produced colored byproducts. It has previously been reported that acetyl pyranoanthocyanins experience both a hyperchromic and hypsochromic shift in response to up to 200 ppm sulfites, and it was proposed this was the result of sulfite covalent linkage at the acetyl group in the D-ring, enhancing the molar absorptivity.

The MS/MS data generated provided valuable insight to the structures of the newly formed compounds. Peak A was the only structure that was not present in trace amounts in the control treatment. A positive ion scan revealed a parent m/z of 535. This was +18 mass units (m.u.) compared to 5-carboxypyranocyanidin-3-galactoside. A followup product ion scan revealed a daughter ion of 373 m/z, a transition of −162 m.u. from the parent ion. This is a commonly reported transition for glycosylated molecules and matches the loss of galactose from the structure. This indicates that the aglycone structure is being modified and not the sugar substitution. With a parent m/z of 535, direct condensation of ascorbic or dehydroascorbic was ruled out. Ascorbic acid degradation byproducts were also considered. Ascorbic acid has previously been reported as being catalyzed by trace levels of metal (1 μM) to form hydrogen peroxide. Ascorbic acid could form hydrogen peroxide which then could react with the pyranoanthocyanin, but the typical result would involve loss of color and a different mass transition. Without wishing to be bound by theory, it is believed that the mechanism which occurs is related to the condensation of the pyranoanthocyanin with other AA degradation products, and perhaps even the rearomatization of the molecule.

Peak B, under positive ionization, had a parent m/z of 519, and the respective product ion scan revealed a daughter ion at 357 mass units. Peak C had a parent m/z of 503 and the product ion scan revealed a daughter with 341 mass units. The shifts for all structures was −162 mass units from parent to daughter ion, which was again attributed to the loss of galactose. This transition shows that the structural modification is occurring on the pyranoanthocyanin aglycone and not the sugar moiety. It is important to point out that the m/z of peak C was lower than that of the starting pyranoanthocyanin (5-carboxypyranocyanidin-3-galactoside, m/z 517), with a loss of 14 units. Of the three new compounds, the structural modification induced by ascorbic acid addition was isolated to the aglycone. Interestingly, single ion monitoring for possible direct condensation products of ascorbic or dehydroascorbic acid with 5-carboxypyranocyanidin-3-galactoside (675 and 673 m/z, respectively) did not appear in the chromatogram. This indicates that the newly formed peaks are not the result of the direct condensation of ascorbic and dehydroascorbic acids with the pyranoanthocyanin.

To further test whether the formation of the new peaks was in response to hydrogen peroxide formed as a byproduct of ascorbic acid degradation, the treatment was repeated except with hydrogen peroxide in place of ascorbic acid. The sample was monitored with 0-, 8-, and 24-h injection times and only revealed a reduction in the original pyranoanthocyanin. Surprisingly, the three new peaks formed in response to ascorbic acid were not formed in response to direct H₂O₂ addition. No MS/MS transitions observed with PACN+AA were found by the addition of H₂O₂. With the three peaks absent in both the PDA and MS chromatogram, this theory was rejected. It was thought that ascorbic acid was degrading and that byproducts other than H₂O₂ were reacting with the pyranoanthocyanin.

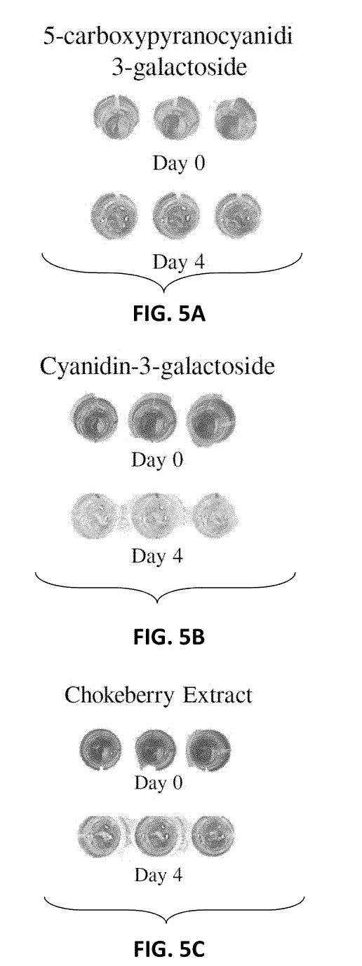

FIGS. 5A-5C are photographs of the color changes for 5-carboxypyranocyanidin-3-galactoside (FIG. 5A), cyanidin-3-galactoside (FIG. 5B), and chokeberry (FIG. 5C) on day 0 and day 4.

These new peaks were not formed during the storage of the 5-carboxypyranocyanidin-3-galactoside control, showing their formation is the result of interaction of PACN with AA. The new peaks had λₘₐₓ of 486 nm and 478, which differed from that of 5-carboxypyranocyanidin-3-galactoside (λₘₐₓ of 502 nm) and explain the change in hue angle towards more orange-red as the new peaks formed. These results show alternative sites of interaction between 5-carboxypyranocyanidin-3-galactoside and AA, given that access to C4 has been blocked.

Auto-oxidation of AA in solution can give rise to H₂O₂ formation, a powerful bleaching agent that can further lead to rapid ACN degradation. To determine whether the changes observed are the result of H₂O₂ formed from AA, direct addition of H₂O₂ was investigated for effect on pigments. Hydrogen peroxide was added to 5-carboxypranocyanidin-3-galactoside and chokeberry extract. HPLC profiles as well as maximum absorbance and λₘₐₓ of the solutions were evaluated. Similar results to those previously described after addition of AA were observed for the chokeberry extract in the presence of H₂O₂, a rapid reduction in the original peaks (11% remaining after 1 day with H₂O₂ addition). For 5-carboxypyranocyanidin-3-galactoside, the pigment was more resistant to bleaching compared to anthocyanins as seen in with AA addition; however, no newly-formed chromophores developed. There was also no hypsochromic shift in λₘₐₓ with H₂O₂ as seen with 5-carboxypyranocyanidin-3-galactoside and AA. This shows that these newly formed peaks between 5-carboxypyranocyanidin-3-galactoside and ascorbic acid are not the result of PACN interactions with hydrogen peroxide and peroxy radicals, but likely another form of AA-driven interaction.

The formation of three new chromophores is the result of AA interaction with PACN at the A, B, or D ring and maintenance of a closed C-ring (FIG. 1). While not wishing to be bound by theroy, it is believed that that an interaction is taking place with the D-ring carboxylic acid of the 5-carboxypyranocyanidin-3-galactoside and ascorbic acid. Such interaction results in a “degradation” chromophore PACN-AA compound.

In contrast, the ACN-AA condensation products preferentially reacted at the nucleophilic C4 and had irreversibly lost aromaticity at the C-ring. For example, cyanidin-3-galactoside degrades rapidly in the presence of ascorbic acid, followed by chokeberry extract. Other phenols in chokeberry extract played a protective role against AA mediated pigment bleaching.

The PACN 5-carboxypyranocyanidin-3-galactoside show greater resistance to bleaching compared to cyanidin-3-galactoside and chokeberry extract with a smaller color change (ΔE) and loss in absorbance in response to ascorbic acid. The interaction between PACN-AA resulted in three new chromophores, not observed when PACN interacted with H₂O₂.

This shows that the mechanism for H₂O₂ and AA bleaching are distinct from one another. These results show that C4 plays an important role as a major—but not the only—site of interaction for AA mediated bleaching of anthocyanins.

Conclusions

Cyanidin-3-galactoside degraded rapidly in the presence of ascorbic acid, followed by chokeberry extract. Other phenols in chokeberry extract likely played a protective role against AA-mediated pigment bleaching. The 5-Carboxypyranocyanidin-3-galactoside colored solution exhibited the smallest change in color (DE) and limited bleaching in response to ascorbic acid (for 1000 mg/L AA, DE of 5.2 versus 27.6 for cyanidin-3-galactoside). The interaction between PACN-AA resulted in the formation of three new chromophores, as revealed by HPLC. The site of reaction for PACN-AA as well as the ACN-AA reactivity are uncertain. The fact that PACN, with the C4 position blocked, still exhibited limited bleaching, further indicates that C4 plays an important, but not singular, role in the AA-mediated bleaching of anthocyanins. The pyranoanthocyanin better maintained absorbance and color expression in the presence of AA, not as a result of 5-Carboxypyranocyandin-3-galactoside survival, but due to the formation of colored byproducts at alternative sites.

### Example II—Juice Model

Anthocyanins fade rapidly in the presence of ascorbic acid, resulting in decoloration or bleaching. In response to ascorbic acid, pyranoanthocyanins exhibit greater resistance to bleaching. This is due to the formation of degradation compounds forming between the pyranoanthocyanin and ascorbic acid, resulting in compounds containing a chromophore like the pyranoanthocyanin it formed from.

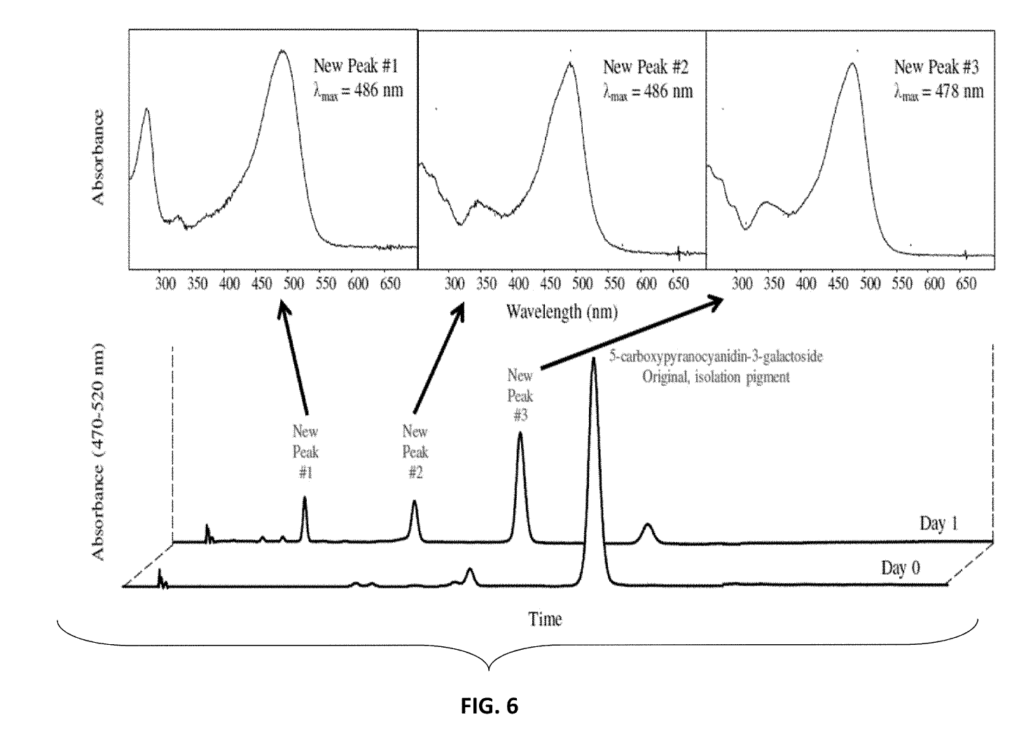

FIG. 6 shows the evolution of a model juice over 1 day with 1000 mg/L ascorbic acid (2-4× typical commercial levels), revealing the formation of these new compounds. The newly-formed compounds eluted earlier than the original isolated structure. In addition, their λₘₐₓ was lower than the original pyranoanthocyanin (478, 486 nm for new compounds versus 503 nm for the original pyranoanthocyanin.

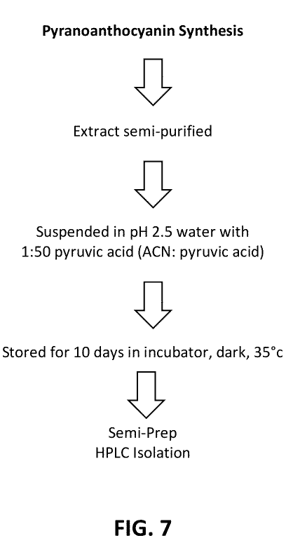

FIG. 7 is a flow chart showing one example of a pyranoanthocyanin synthesis.

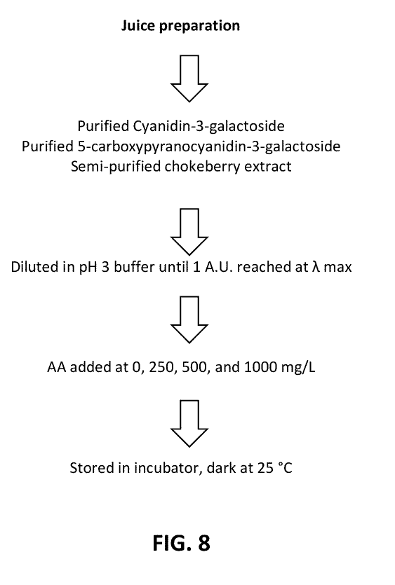

FIG. 8 is a flow chart showing one example of a process for juice preparation.

### Example III—Influence of Cyaniding Glycosylation Patterns of Carboxypyranoanthocyanin Formation

The influence of anthocyanin-glycosylation in pyranoanthocyanin yield was also evaluated. Pyranoanthocyanin formation was more influenced by believed stereochemistry of glycosidic bonds more so than the number of sugars. Anthocyanin precursors containing 1→6 glycosidic linkages from carbon-3 promoted pyranoanthocyanin formation while 1→2 linkages restricted it. C3-glucoside, C3-galactoside, and C3-xylosyl(1→2)glucosyl(1→6)galactoside resulted in pyranoanthocyanin yield that was intermediate to the 1→2 and 1→6 yields.

Anthocyanins can condense with compounds having enolizable groups to form pyranoanthocyanins. These pigments are less susceptible to degradation and color changes associated with nucleophilic addition common to anthocyanins. This example aimed to evaluate the impact of glycosylation patterns of anthocyanins on carboxypyranoanthocyanin formation. Nine cyanidin derivatives were isolated by semi-preparative HPLC. Pyruvic acid was added to induce pyranoanthocyanin formation. Composition (HPLC-MS/MS), spectra (absorbance 380-700 nm), and color (CIEL*c*h*) of solutions were monitored during 31 days storage at 25° C. Cyanidin-3-glycosides with 1→6 disaccharides produced the highest pyranoanthocyanin yield (˜31%), followed by cyanidin-3-monoglycosides (˜20%); 1→2 disaccharides produced the least proportions of pyranoanthocyanins (5-7%). Cyanidin-3-arabinoside converted to pyranoanthocyanins but degraded quickly (3% yield) under these conditions. No pyranoanthocyanins were formed from cyanidin-3-sophoroside-5-glucoside. Glycosyl bonds were more critical than the size of the substitution alone, further supported by Cyanidin-3-(glucosyl)-(1→6)-(xylosyl-(1→2)-galactoside) yield (11%). Pyranoanthocyanins were hypsochromically shifted and had higher hue angles than their respective anthocyanins.

With over 700 unique anthocyanins reported in literature, there is a great degree of natural structural diversity which can be an important component in the formation of these derived pigments. This example evaluates how different glycosylation patterns influence pyranoanthocyanin formation, more specifically focusing on mono-, di-, and tri-glycosylation at C3 of cyanidin and the influence of sugar moiety branching patterns of the disaccharides. It was believed that, generally, as the size of the substitution at C3 grows, pyranoanthocyanin formation would be hindered. Pentosides and monoglycosides, being smaller, would be more favorable than a hexosyl substitution or di- or tri-glycosides in pyranoanthocyanin formation, comparatively. C5 substitution was believed to inhibit any pyranoanthocyanin formation. Therefore, an anthocyanin with 3,5-glycosylation was included.

Materials and Methods

Materials

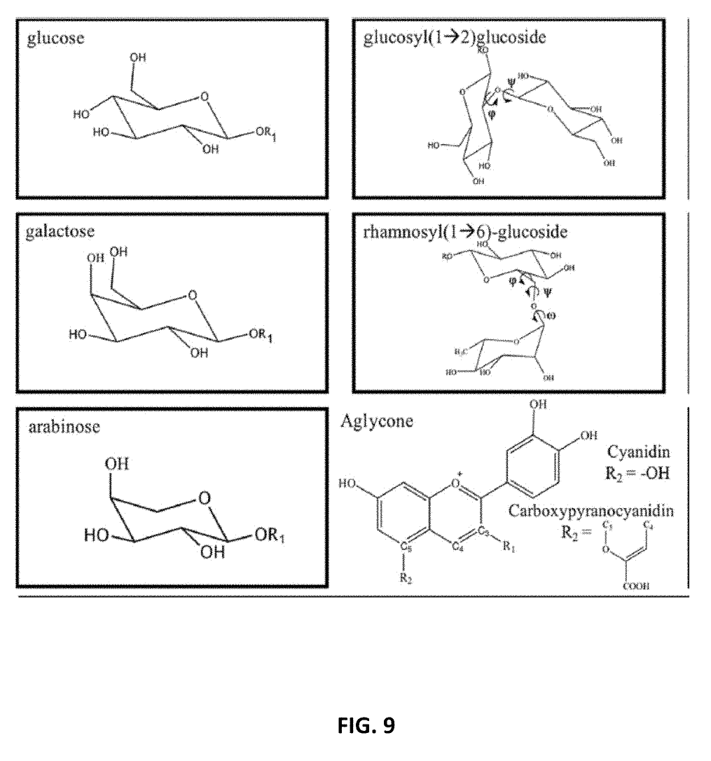

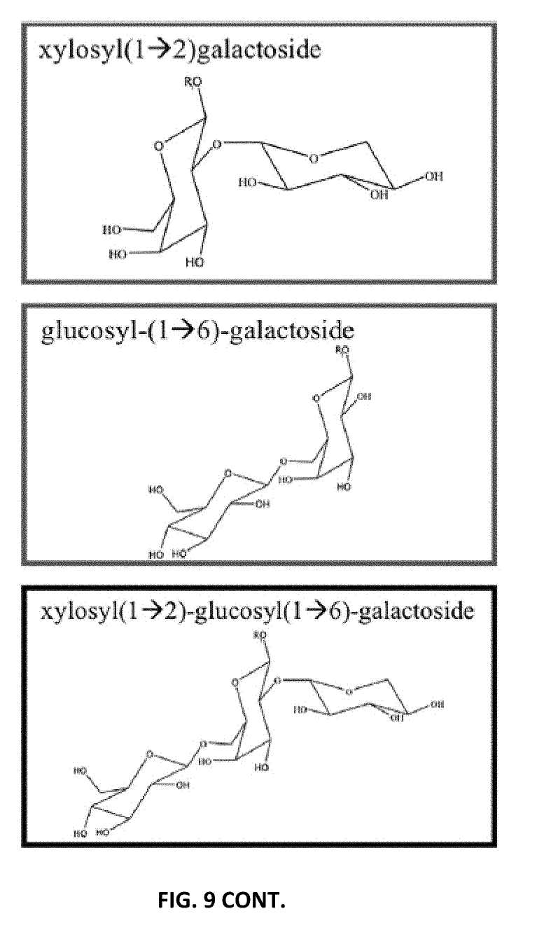

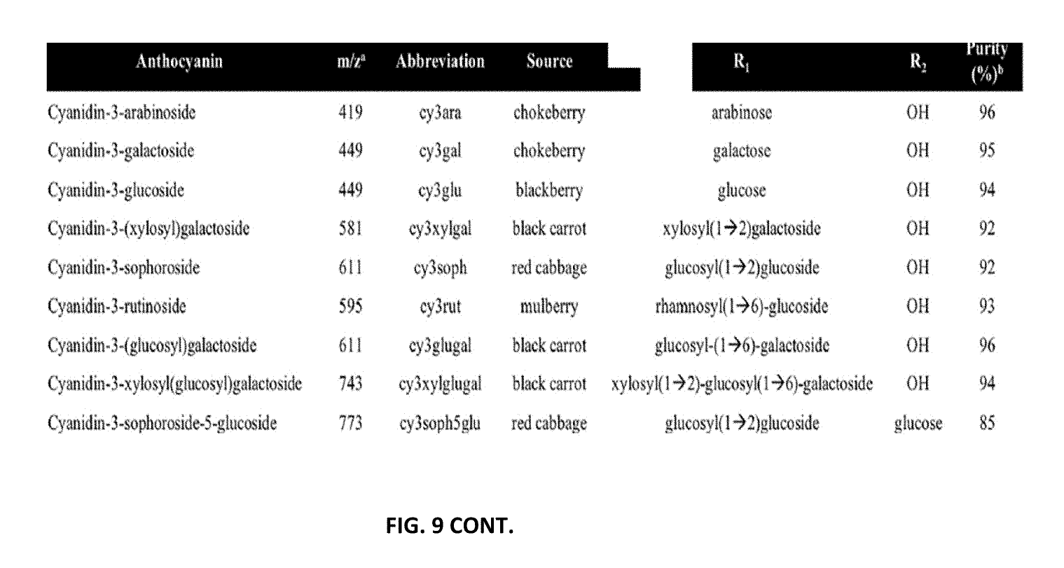

Several plant materials were used for the isolation of specific anthocyanins. Blackberry (Rubus sp.) was selected as a source of cyanidin-3-glucoside. Chokeberry (Aronia melanocarpa) was selected for isolation of cyanidin-3-galactoside and cyanidin-3-arabinoside. Black carrot (Daucus carota L.) was used as a starting material for cyanidin-3-(xylosylglucosyl) galactoside, cyanidin-3-(xylosyl)galactoside, and cyanidin-3-(glucosyl)galactoside. Mulberry (Morus nigra) was selected as a source of cyanidin-3-rutinoside. Red cabbage (Brassica oleracea L.) was used as starting materials for preparation of cyanidin-3-sophoroside and cyanidin-3-sophoroside-5-glucoside. The structures of the isolated anthocyanins, along with the abbreviations, are displayed in FIG. 9.

Methods

Anthocyanin Extraction and Semi-Purification (SPE)

Anthocyanin rich extracts of blackberry and mulberry were prepared from fresh materials obtained from a local grocery store and harvested from local trees, respectively (Columbus, Ohio, U.S.). Extraction of anthocyanins from plant materials followed procedures described previously using aqueous acetone and partition with chloroform. Black carrot, chokeberry, and red cabbage, obtained in commercial powdered forms, were hydrated in acidified water (0.01% HCl) prior to semi-purification. To achieve high yields of the cy3xylglugal and cy3xylgal, hydrated black carrot was subjected to saponification (alkaline hydrolysis), using 10% KOH to remove the hydroxycinnamic acid substitution on the acylated pigments. The same procedure was used to obtain cy3soph5glu from acylated pigments in red cabbage. Cy3glugal, not being a part of the original black carrot anthocyanin profile, was formed by subjecting the saponified black carrot anthocyanins to partial acid hydrolysis, using 2N HCl at boiling temperature to induce loss of xylose from cy3xylglugal. The same technique was used to form cy3soph from cy3soph5glu from red cabbage. Instead of the full suggested time of thirty minutes to remove all sugar moieties, the saponified pigments were only exposed to eight minutes of acid boil. The peaks were then isolated by semi-preparative HPLC as described below.

The solutions were then loaded onto a C18 cartridge (Waters Seppak) for solid phase extraction (SPE). With the pigment bound to the activated column, two volumes of acidified water (0.01% HCl) were passed through to wash sugars and polar components. This was followed by addition of two volumes of ethyl acetate to remove less polar phenols. The bound pigment was recovered in acidified methanol (0.01% HCl). The acidified methanol was removed by use of a Buchi rotovap (New Castle, Del., U.S.) under vacuum at 35° C. The pigment was resolubilized in acidified water (0.01% HCl) and frozen for further use.

Anthocyanin Isolation

The pigments listed in the materials section were isolated from the extracts through the use of semi-preparative HPLC. A semi-preparative HPLC that included the following modules was used: LC-6AD pumps, CBM-20A communication module, SIL-20A HT autosampler, CTO-20A column oven, and SPD-M20A Photodiode Array detector (Shimadzu, Md., U.S.). A 50×21.2 mm (5 μm particle size) Luna pentafluorophenyl column was used for separation of anthocyanins (Phenomenex, Calif., U.S.). Samples were filtered prior to injection with a Phenex RC 0.45 μm, 15 mm membrane syringe filter (Phenomenex, Calif., U.S.).

A 10 mL/min flow rate was used in combination with a binary gradient for separation for all anthocyanin isolation, and UV-Visible absorbance data was collected from 260 to 700 nm. Solvent A was 4.5% formic acid in water and solvent B was 100% acetonitrile. The gradient for isolation of black carrot and chokeberry anthocyanins started with holding 10% solvent B for 10 min followed by a ramp to 13% solvent B by 25 min. Anthocyanins from hydrolyzed red cabbage and blackberry were isolated with a gradient beginning at 10% B and increased to 35% by 50 min. For isolation of cy3rut from mulberry, the gradient was 8% B for the first minute and increased to 20% B over 50 min.

The anthocyanin isolate fractions collected from semi-preparative HPLC were diluted in a 1:1 ratio with distilled water and concentrated by the same SPE treatment described above with rotovapory drying used for plant extracts. This allowed for the removal of acetonitrile and formic acid. Isolated anthocyanins were tested for purity and then frozen until use in the sample preparation step.

Anthocyanin Purity and Monitoring of Pigments

A uHPLC system (Shimadzu Nexera-i LC-2040C, Maryland, U.S.) coupled with tandem MS (Shimadzu LCMS-8040, Maryland, U.S.) was used in evaluating initial anthocyanin purity and monitoring changes in anthocyanins with and without pyruvic acid treatment over time. A 0.4 mL/min flow rate was used on a Pinnacle DB (Restek Corporation, Bellefonte, Pa.) C18 Column (1.9 μm particle size, 50×2.1 mm length). The column oven was set at 40° C. The following gradient of solvent A (4.5% formic acid) and B (100% acetonitrile) was used: 0% B for the first minute, ramped to 15% B by 10 min. This method was effective for separation of the formed pyranoanthocyanin from anthocyanin for all isolates except cy3rut which coeluted with the formed pyranoanthocyanin. This was observed through MS-MS data. In order to obtain separation of this isolate and its pyrananthocyanin derivative, the oven temperature was increased to 60° C., and the solvent gradient was held isocratic at 2% solvent B for 10 min.

Mass spectrometry was used to tentatively identify parent structures and respective aglycones of isolates. Ionizing conditions from electrospray ionization included the following: 1.5 L/min nebulizing gas flow, 230° C. desolvation line temperature, 200° C. heat block temperature, and 15 L/min drying gas flow. M+H of intact structures was evaluated using a Q1 positive scan with a range of 100-1000 m/z and event time of 100 ms. Both the cyanidin and carboxypyranocyanidin aglycone were evaluated using precursor ion scans. A collision energy of −35.0 eV was used with a secondary collision event (argon gas) with the cyanidin aglycone scan looking for product ions of 287 m/z and carboxypyranocyanidin of 355 m/z. The difference between the parent structure of the anthocyanin and the pyranoanthocyanin was +68 m/z.

Purity of the anthocyanin isolates was described as the percent area under curve for the target anthocyanin as compared to the total area of all peaks in the max plot from PDA data (260-700 nm). Pigment purities are reported in FIG. 9. Cy3soph5glu was found to contain an unidentified phenolic, lowering purity to 85%. All others had <8% of impurities; however, Cy3xylglugal contained minor amounts of cy3-xylgal. Cy3xylgal also contained minor amounts of cy3xylglugal and cy3 gal.

Pyranoanthocyanin formation was quantified in the following terms:

$$Pyranoanthocyanin yield ( \% ) = \frac{AUC of PACN at time {point}_{500 - 520 nm}}{AUC of ACN at day {0}_{500 - 520 nm}} \times 100$$

Quantification of pigments was conducted on day 0, 3, 7, 14, and 31 using a standard curve of cyanidin-3-glucoside (Sigma Aldrich, St. Louis, Mo., U.S.) run under the same conditions used for isolates. Molar absorptivities of anthocyanins and carboxypyranoanthocyanidins have been reported as being relatively similar and were thought to provide a basis of confidence in using AUC500-520 nm as a quantitative measure of pyranoanthocyanin yield.

Sample Preparation

Prior to dilution, the concentrations of the isolated pigment extracts were determined by the pH differential method for subsequent dilution to known concentrations. The isolates were then diluted to 500 μM (expressed as Cyanidin-3-glucoside equivalents) in pH 2.5 deionized water (previously adjusted with HCl) which contained 0.1% potassium sorbate (w/v) and 0.1% sodium benzoate (w/v) to function as preservative agents during storage. A pH of 2.5 was selected as a compromise of several variables: the flavylium form was predominant, the effect of pKh was minimized, and it is a relevant pH for wines. It has been reported that the pKh's of cy3 gal, cy3xylgal, and cy3xylglugal ranges from 3.01 to 3.26. Working at pH 2.5 largely avoided the effect of different equilibrium forms while also maintaining a pH that is similar to that of wines where these compounds are commonly formed. Control samples of each isolate were prepared and contained no pyruvic acid. For treatments containing pyruvic acid, a previously diluted pyruvic acid standard (pyruvic acid in the same pH 2.5 water containing preservatives) was added to obtain concentrations 100× the molar ratio of anthocyanins (50 mM of pyruvic acid). All treatments were brought to the same final volume by the addition of more pH 2.5 water. Samples were filtered through a 0.2 μm membrane into 1.5 mL glass HPLC vials. Vials were capped and stored in an incubator in the dark at 25° C. for a 31 day duration (Fisher Scientific, Waltham, Mass., U.S.). All treatments were prepared in triplicate.

UV-Vis Spectrophotometry of Samples

Absorbance spectra of anthocyanin isolates subjected to pyruvic acid treatment was collected using a SpectraMax 190 microplate reader (Molecular Devices, Sunnyvale, Calif., U.S.). Sample aliquots (75 μL) were loaded in a 96-well plate (poly-D-lysine coated polystyrene). Samples were evaluated from 380 to 780 nm in 1 nm intervals. The blank consisted of the same acidified pH 2.5 water solution used to dilute pigment samples. Spectra were collected on day 0, 7, 14, and 31. Spectrophotometric data of the samples was used to correlate with pyranoanthocyanins formation.

Colorimetry of Samples

Colorimetric data of samples was calculated from spectra of samples collected from the plate reader with ColorBySpectra. Absorbance data was obtained and conversion to color values was achieved using the following settings: regular transmission, D65 illuminant, and 10° observer angle. Values reported are in the CIEL*c*h* scale. After storage for 31 days, the mathematical differences in color (ΔE) were calculated according to the CIE-L*a*b* Delta E2000 equation. Colorimetric data of the samples containing pyruvic acid was used to correlate with pyranoanthocyanins formation. Spectral absorbance data of the peaks of the anthocyanins and their respective pyranoanthocyanins were also collected from the PDA during uHPLC analyses and converted to colorimetric data using ColorBySpectra under the settings described above. The spectra was obtained from the time of elution of the target compound and then standardized to an absorbance of 1.0 at λᵥᵢₛ₋ₘₐₓ.

Statistical Analysis of Data

Evaluation of data was performed to determine significance of findings. Two-Way ANOVA was performed to evaluate pyranoanthocyanin yield and color changes in respect to substitution, time, and the substitution*time interaction. One-Way ANOVA was also conducted to compare final yields (day 31) between different pigment substitutions. Correlation among anthocyanins capable of producing pyranoanthocyanin was conducted to relate pyranoanthocyanin yield to changes in color and spectral characteristics using Pearson's Correlation (two-tailed). The survival of anthocyanins (day 31, %) in the control sample was also compared to the final pyranoanthocyanin yield (day 31, %) of pyruvic acid treated samples to see if the two parameters were correlated. SPSS was used to carry out these tasks (International Business Machines, Armonk, North Castle, N.Y.).

Results & Discussion

Kinetics Ofpyranoanthocyanin Formation

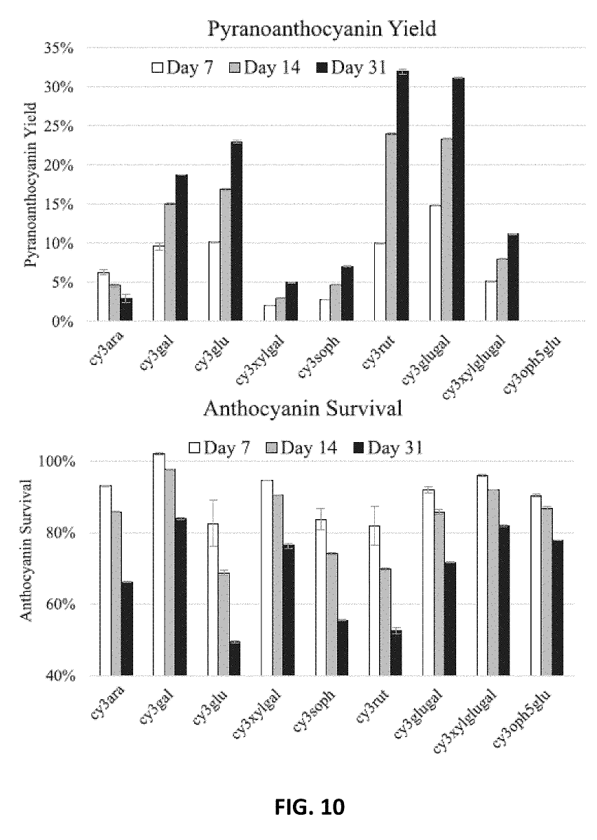

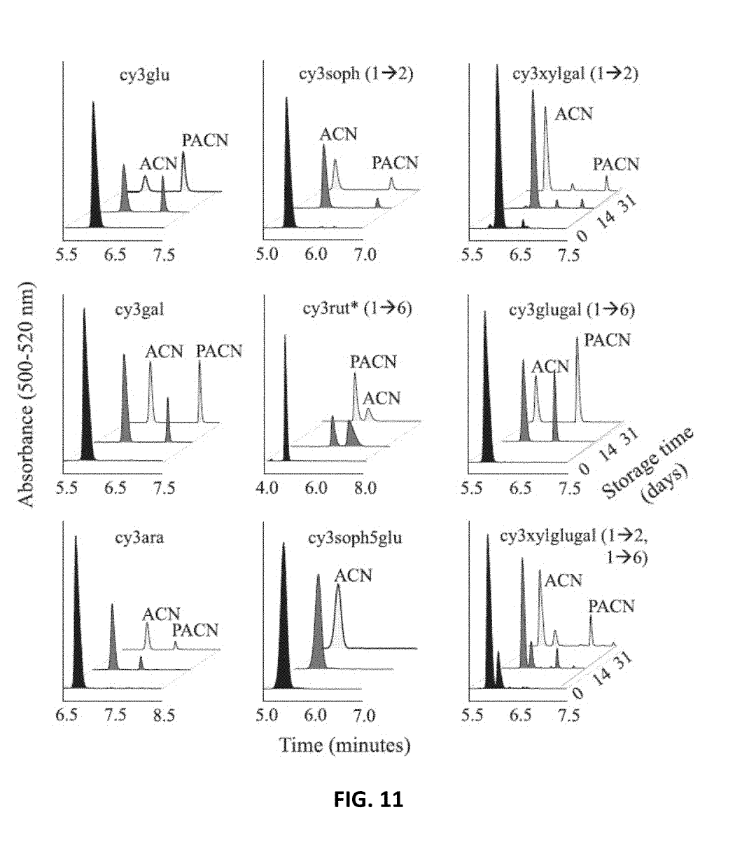

All isolated cyanidin derivatives formed pyranoanthocyanins with the addition of pyruvic acid, with the exception of cy3soph5glu, further demonstrating the necessity of the availability of the anthocyanin C5 hydroxyl group. However, the percent of anthocyanin converted to pyranoanthocyanin of each isolate was dependent on the chemical structure of the pigment (shown in FIG. 10), and the evolution of the pyranoanthocyanin peak formation from HPLC is displayed in FIG. 11. It was believed that pyranoanthocyanin yield would be inversely proportional to the size of the 3-substitution with the expected order: cy3ara (pentose)>cy3gal≈cy3glu (hexose)>cy3xylgal≈cy3-soph≈cy3rut≈xy3glugal>cy3xylglugal>>cy3soph5glu. However, the following order was observed from the experimental data: cy3rut (32%)>cy3glugal (31%)>cy3glu (23%)>cy3 gal (19%)>cy3-xylglugal (11%)>cy3soph (7%)>cy3xylgal (5%)>cy3ara (3%). Both time and pigment substitution were statistically significant parameters in pyranoanthocyanin formation (p-value<0.001). This order was surprising and may have several important implications in understanding pyranoanthocyanin formation kinetics.

By comparing the survival of the anthocyanin in control treatments to the pyranoanthocyanin yield (FIG. 10), it did not appear as if pigment stability dictated the extent of pyranoanthocyanin formation at pH 2.5. The survival of the control pigments ranged from 84% (cy3 gal) to 49% (cy-3-glu) by day 31. Cy3soph and cy3rut control treatments had shorter half-lives among the 9 isolated anthocyanins, yet cy3rut had one of the highest and cy3soph one of the lowest pyranoanthocyanin yields. Correlation of anthocyanin survival of control treatments and pyranoanthocyanin yield of the pyruvic acid treated samples showed no trend between the two variables at day 31 (Pearson Correlation=−0.281, p-value=0.184). At day 7, cy3ara had the third highest pyranoanthocyanin content among the nine isolates (6%); however, the formed pyranoanthocyanin decreased at day 14 (5%) and day 31 (3%). It is likely that pyranoanthocyanin derived from cy3ara was less stable than pyranoanthocyanins derived from the other isolates. This was an unusual finding considering the stability of the control treatment had 66% anthocyanin survival by day 31 and was not the least stable of the anthocyanins that did yield pyranoanthocyanins.

Another interesting observation from this data is the disaccharides cy3rut and cy3glugal, bearing sugars with 1→6 glycosyl linkages, had the greatest pyranoanthocyanin yield (31-32% at day 31) among all pigments, a 9% increase from the next greatest yield (cy3glu, 23%). In the case of these select isolates, size might not have been the greatest factor in formation; perhaps the free rotation of glycosidic bonds as well as conformation were greater driving forces in pyranoanthocyanin formation. With disaccharides clustered and the rapid degradation of carboxypyranocyanidin-3-arabinoside dismissed, the order of pyranoanthocyanin formation was the following: 1→6 disaccharides (cy3rut and cy3glugal)>monosaccharides (cy3glu and cy3 gal)>trisubstituted (cy3xylglugal)>1→2 disaccharides (cy3xylgal and cy3-soph). The difference between 1→6 and 1→2 disaccharides alone was an over 5-fold difference in final pyranoanthocyanin yield. Higher yield in 1→6 disaccharides versus monosaccharides and 1→2 disaccharides indicated the 1→6 glycosyl linkage may have enhanced the reaction, possibly having a greater degree of freedom in rotation; whereas, the 1→2 glycosyl linkage, could have inhibited free movement of the substitution at C3. This is also supported by cy3xylglugal, having both the 1→2 and 1→6 linkage, yielding greater formation than disaccharides with 1→2 glycosyl linkages.

All disaccharides in this example have two torsion angles, phi (φ) and psi (Ψ), around the glycosidic bond. However, 1→6 linked sugars have an additional torsion angle between C5 and C6 of the attached sugar called omega (ω), FIG. 9. This additional torsion angle has been reported as having greater rotational freedom in the glycosidic bond. Conformational analysis of disaccharide glycosidic bonds have been analyzed for rotational freedom, intramolecular hydrogen bonding, and configurational entropy in water. These studies have shown that 1→6 linked disaccharides have significantly greater rotational flexibility in water, more conformational states, lack intramolecular hydrogen bonding, and have greater configurational entropy as compared to 1→2 linked disaccharides. This indicates that the 1→6 disaccharide substituted anthocyanins possessed greater rotational freedom and may be important in pyranoanthocyanin formation.

Disaccharide-substituted anthocyanins with 1→2 glycosidic bonds may have had restricted stereochemistries due to the rather limited range in φ and γ angles and possible intramolecular hydrogen bonding, whereas the 1→6 glycosidic bond (φ, Ψ, and ω) contributed to a greater number of conformational states and enhanced free rotation. This free rotation was thought to be aiding in the correct positioning of pyruvic acid or simply moving out of the way and allowing the heterocyclic SN2 reaction between pyruvic acid and the anthocyanin to occur. Free rotation of these disaccharides may play a role in increasing the reaction kinetics by increasing collision between the reactants, while the intramolecular hydrogen bonding in 1→2 disaccharides could have limited the mobility of the system and access of pyruvic acid to the critical site of the anthocyanin. As 1→6 disaccharide substituted anthocyanins had greater pyranoanthocyanin yield than the reported monosaccharides, it was thought that these disaccharides are more likely aiding in positioning pyruvic acid for reaction versus just moving out of the way. This is further supported by cy3xylglugal, containing both 1→2 and 1→6 glycosyl bonds, having greater formation than 1→2 disaccharide anthocyanins.

Development of the new pyranoanthocyanin peaks can be observed in FIG. 11. The AUC of the new pyranoanthocyanin peaks was greater over time with two exceptions, cy3soph5glu had no new peak development and newly formed carboxypyranocyanidin-3-arabinsode reduced in AUC over time. Under these HPLC conditions, newly formed pyranoanthocyanin peaks eluted 0.8-1.0 min after the original anthocyanin, with the exception of cy3rut. This isolate had the pyranoanthocyanin (carboxypyranocyanidin-3-rutinoside) coelute under original HPLC conditions which was unexpected but confimed by MS/MS data. Due to the observed coelution for this pyranoanthocyanin, a partially isocratic HPLC method was utilized to separate the pyranoanthocyanin and its parent anthocyanin. This resulted in broadening of the peaks as they eluted from the column.

Changes in Anthocyanin Spectra During Reaction with Pyruvic Acid

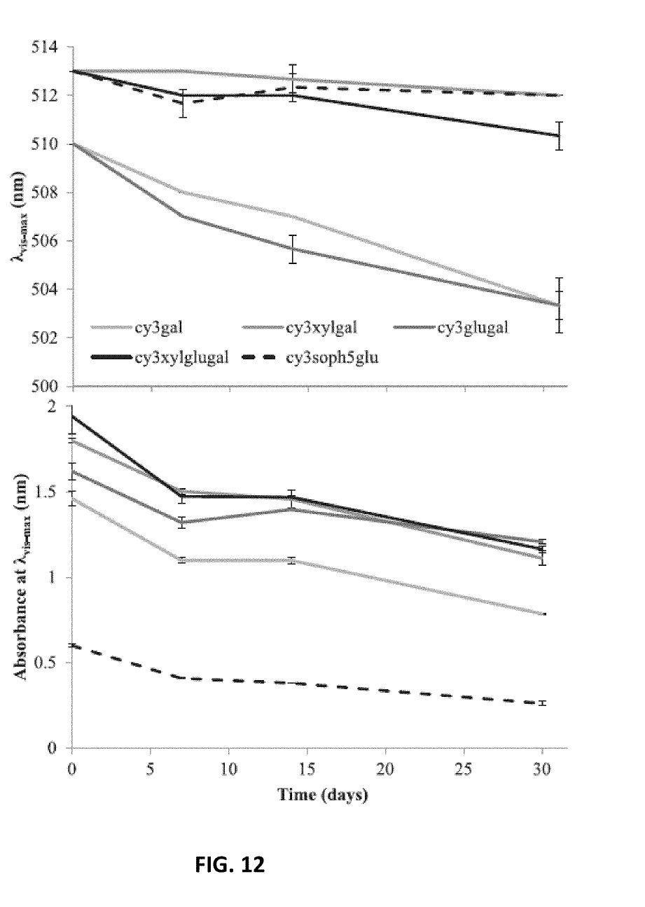

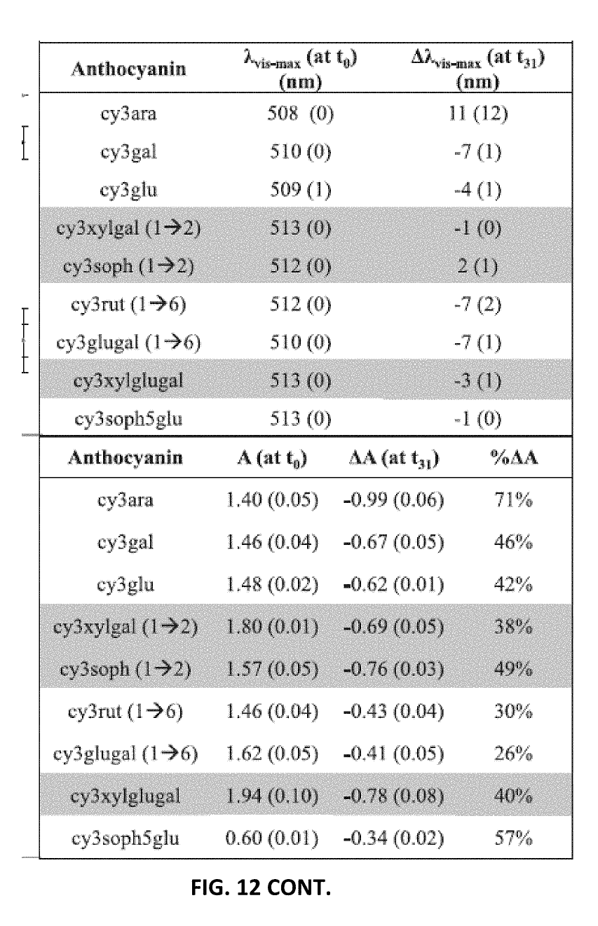

Spectral characteristics of the anthocyanins treated with pyruvic acid were monitored by visible spectrophotometry during storage over 31 days, FIG. 12. Maximum absorbance decreased for all isolates. The greatest decrease in absorbance was observed for cy3ara, which showed a 71% decrease in absorbance after 31 days, FIG. 12. The high rate of degradation of the formed pyranoanthocyanin from cy3ara likely contributed to it having the greatest loss in absorbance. Anthocyanins diglycosylated with 1→6 linked sugars showed smallest decreases in absorbances, 26% and 30% for cy3glugal and cy3rut, respectively. The higher pyranoanthocyanin yield could be responsible for helping better maintain maximum absorbance.

The λᵥᵢₛ₋ₘₐₓ of the solutions of the anthocyanins treated with pyruvic acid were also impacted. There appeared to be a relationship between pyranoanthocyanin yield and the hypsochromic shift of isolates. Those anthocyanins that yielded the highest proportions of pyranoanthocyanins exhibited the largest hypsochromic shifts in λᵥᵢₛ₋ₘₐₓ. For example, cy3glugal and cy3rut yielded 31-32% pyranoanthocyanins, and their λᵥᵢₛ₋ₘₐₓ was shifted−7 nm, FIG. 12. The anthocyanin monoglycosides followed in terms pyranoanthocyanin yield as well as hypsochromic shifts in λᵥᵢₛ₋ₘₐₓ. Cy3xylglugal, the anthocyanin trisaccharide, yielded greater proportions of pyranoanthocyanins than the 1→2 disaccharide glycosylated anthocyanins and also exhibited greater hypsochromic shifts, FIG. 12. Overall, hypsochromic shift and pyranoanthocyanin yield were negatively correlated (Pearson Correlation=−0.575, p-value<0.001). This relationship may be a useful tool in evaluating the extent of pyranoanthocyanin yield in similar model system. Unlike the other anthocyanins, cy3ara underwent a bathochromic shift by day 31; however, there was also a large standard deviation. These attributes were the result of the degradation of the formed pigments.

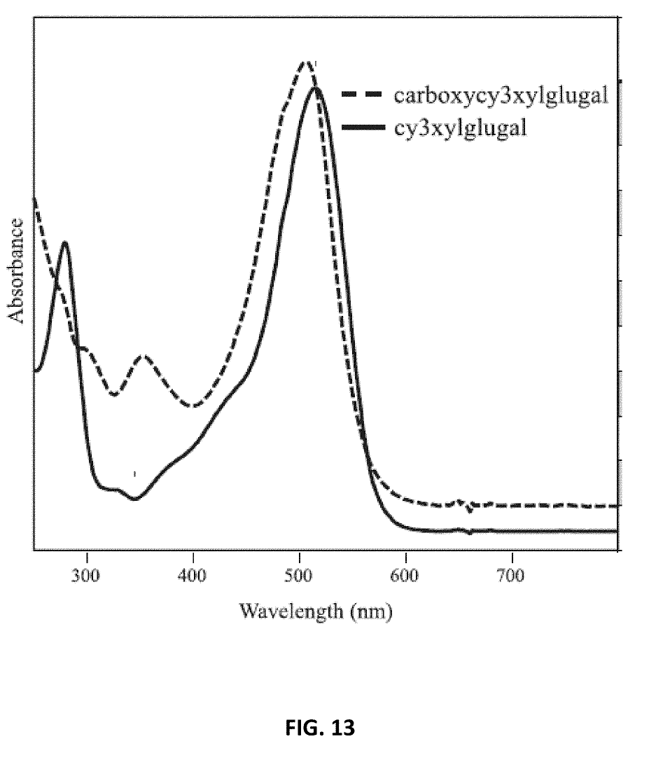

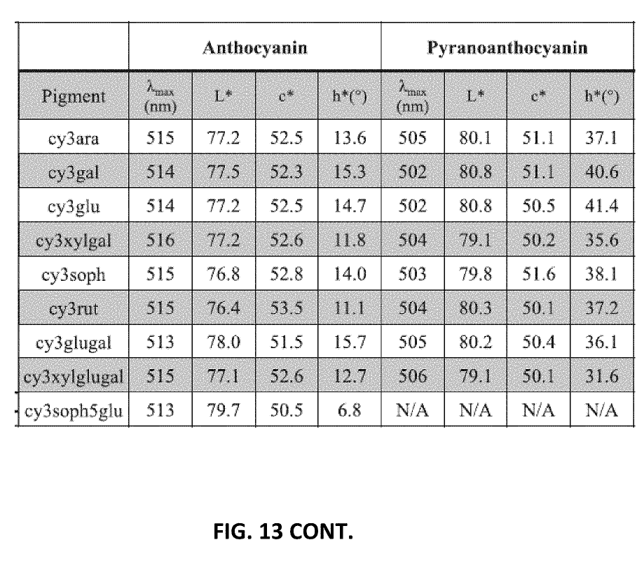

Absorbance spectra of isolates and newly formed pyranoanthocyanins were also collected from the PDA detector during uHPLC analysis. The formation of the fourth ring on the anthocyanin chromophore resulted in several changes in the typical anthocyanin absorbance spectra. The pH at time of elution was ˜1.74 for the peaks. As previously mentioned, hypsochromic shifts in λᵥᵢₛ₋ₘₐₓ are known to occur with anthocyanin to pyranoanthocyanin conversion; however, the degree of the shift was found to differ among the anthocyanin isolates and their pyranoanthocyanin-derivatives, FIG. 13. Similarly, the λᵥᵢₛ₋ₘₐₓ of four cyanidin-pyruvic adducts bearing glucose, rutinose, sophorose, or sambubiose ranges from 503 to 506 nm in aqueous buffer pH 2. The differences in λᵥᵢₛ₋ₘₐₓ between the anthocyanins and associated pyranoanthocyanins ranged 8-12 nm, with the greatest decreases in λᵥᵢₛ₋ₘₐₓ noted for cy3glu, cy3 gal, cy3-xylgal, and cy3soph (12 nm). It was believed that conversion to the carboxypyranoanthocyanin would have resulted in nearly the same hypsochromic shifts because the modification to the each chromophore would have been chemically similar. These findings indicate the structure of the glycosylating moiety may play a role in the λᵥᵢₛ₋ₘₐₓ and color expression of pyranoanthocyanins. In the case of anthocyanins, the interaction of the chromophore with light (therefore color expression) can be altered by structural distortions of the aglycone (stretching, bending, or torsion), which may be affected by chemical substitution patterns.

The conversion of anthocyanin to pyranoanthocyanin also altered spectral characteristics beyond λᵥᵢₛ₋ₘₐₓ, FIG. 13. Anthocyanins with 3-glycosylations typically exhibit a characteristic absorbance shoulder between 420 and 440 nm. This shoulder was eliminated or hidden when the pigment was converted to a carboxypyranoanthocyanin. Another characteristic difference of pyranoanthocyanin spectra as compared to anthocyanin spectra is the loss of the shoulder at 280 nm, typical of flavonoids. Additionally, a new peak at 352-353 nm was found, consistent with the spectral distribution of pyranoanthocyanin derivative of malvidin-3-glucoside. The majority of the changes occurred in the UV absorbance region and would not have large effects of the colorimetric properties of the pigments. These spectral qualities were observed for all carboxypyranoanthocyanins formed and have been similarly observed in vitisin A and B formation.

Changes in Anthocyanin Color During Reaction with Pyruvic Acid

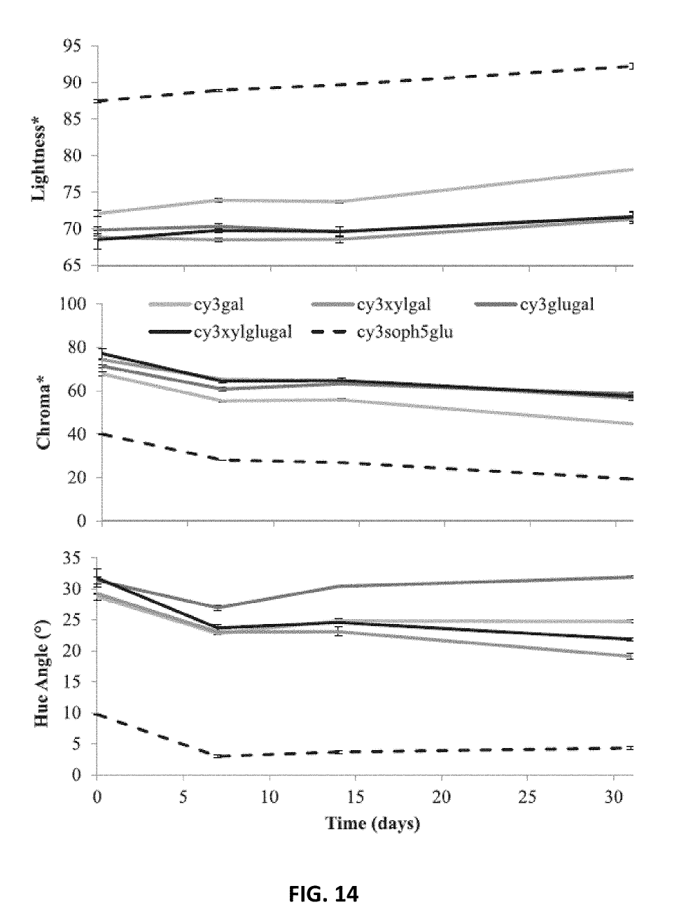

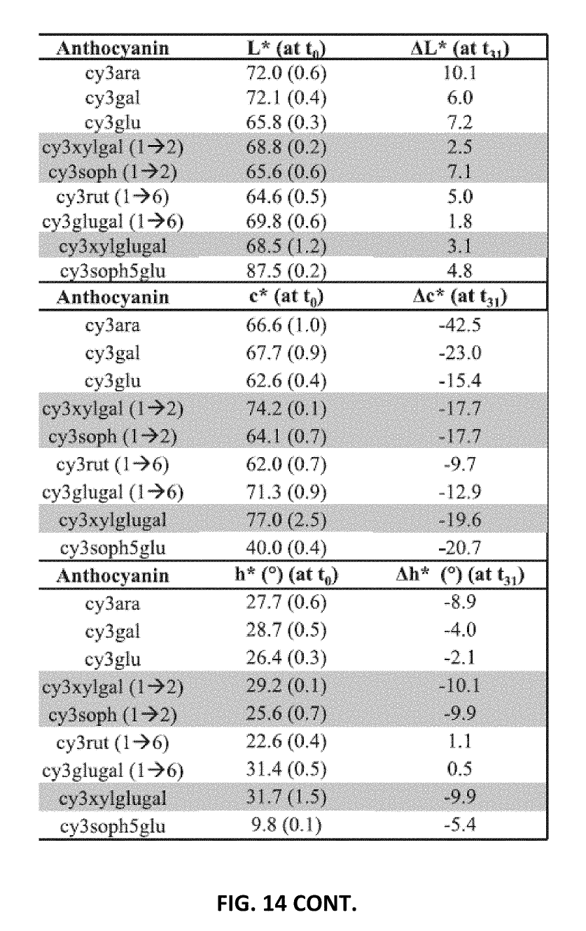

Color changes among the 9 anthocyanin isolates in the presence of pyruvic acid were evaluated over the 31 day period using the CIEL*c*h* color space. Spectral data collected with a plate reader was converted with ColorBySpectra to determine colorimetric values. Changes in lightness, chroma, and hue angle of solutions can be seen in FIG. 14. For all isolates, lightness increased by day 31. Cy3soph5glu had a higher initial L* (87.5) as compared to anthocyanins lacking a C5 substitution (68.5-72.0). The pKh of Cy-3-glu-5-glu has been reported as 2.23. Therefore, hydration and lighter color expression of cy3soph5glu would be expected to have occurred under the conditions of this example. Cy3ara showed the greatest increase in lightness (ΔL* 10.2) and cy3glugal the smallest (ΔL* 1.8). Chroma, or color saturation, showed a similar pattern. Cy3ara, again, had the greatest change (Δc* −42.5) and cy3rut had the smallest (Δc*−9.7). During storage, all isolates showed overall reductions in chroma and increases in lightness with cy3ara having the greatest amount of color loss.

Hue angles were expected to increase proportionally to greater pyranoanthocyanin yield. Compared to their respective anthocyanins, pyranoanthocyanins are hypsochromically shifted, which is thought to be a contributor for the color evolution of red wine changing from purple-red to brick-red during aging. The following order of pyranoanthocyanin yield was reported above as the following: cy3rut>cy3glugal>cy3glu>cy3 gal>cy3xylglugal>cy3soph>cy3xylgal>cy3ara. Interestingly, only the anthocyanins glycosylated with 1→6 disaccharides demonstrated increases in hue angle (1.1° for cy3rut and 0.5° for cy3-glugal), while all the other pyranoanthocyanin-forming isolates showed decreases in hue angle over time, FIG. 14. Generally, the largest decreases in hue angle were demonstrated by pyruvic acid treated anthocyanins that bore glycosides with 1→2 types of linkages. Cy3ara also showed large decreases in hue as a response to pigment degradation. Unlike the hypothesis that an increase in hue (to appear more red-orange) would occur with pyranoanthocyanin formation, there was not a statistically significant correlation between change in hue angle and pyranoanthocyanin yield of solutions.

The changes in color of samples treated with pyruvic acid were also monitored in terms of ΔE, comparing day 0 and day 31 colorimetric parameters. The following total color change values (ΔE) were observed: cy3ara: 16.4, cy3 gal: 8.2, cy3glu: 7.2, cy3xylgal: 7.8, cy3soph: 9.2, cy3rut: 4.9, cy3glugal: 3.6, cy3xylglugal: 8.3, and cy3soph5glu: 9.7. As indicated from the L*, c* and, h* values, cy3ara showed the greatest color change while cy3rut and cy3glugal demonstrated smallest changes in color. The higher pyranoanthocyanin yields observed with cy3rut and cy3glugal may have played important roles in better maintaining colorimetric stability.

As another point of comparison, colorimetric data was calculated from the absorbance spectra (standardized to absorbance 1.0 at respective λᵥᵢₛ₋ₘₐₓ) of the peaks of the anthocyanins and their respective pyranoanthocyanins under HPLC conditions, FIG. 13. Small differences in L* and c* between the anthocyanin and its respective pyranoanthocyanin were observed despite being standardized, which indicates that the spectral distribution of the pigments had effects on their overall lightness and saturation. An increase in L* and decrease in c* was observed in conversion of the anthocyanin to its pyranoanthocyanin derivative, FIG. 13, demonstrating increases in lightness and decreases in overall color saturation. Hue angles were also increased by ˜20° for all pigments, which correlated to the observed hypsochromic shifts in λᵥᵢₛ₋ₘₐₓ. Thus, the pyranoanthocyanins were comparatively more orange than the anthocyanin precursors. These changes in hue are consistent with pyranoanthocyanin formation in wine and its color evolution from red-purple to a more orange hue.

### CONCLUSION

Glycosidic substitution patterns on C3 of cyanidin played important roles on pyranoanthocyanin-formation efficiency. Number of glycosidic substitutions on the anthocyanin did not completely predict the order of efficiency of pyranoanthocyanin formation. Instead, cy3rut and cy3-glugal, bearing 1→6 disaccharides, converted to carboxypyranoanthocyanins with greater yield. Anthocyanins monoglycosylated with hexoses followed in pyranoanthocyanin yield. Cy3ara showed a high initial rate of carboxypyranoanthocyanin formation, but this was lost by day 31, likely due to the poor stability of its pyranoanthocyanin-derivative. The structure of the glycosylating moiety was demonstrated to play an important role in pyranoanthocyanin formation. The glycosylations comprised of only 1→2 glycosidic bonds showed low carboxypyranoanthocyanin formation while those with 1→6 glycosidic bonds seemed to have enhanced capacity to derivatize. These sugars, as free molecules, have exhibited greater degrees of rotation in solution which, when attached to the anthocyanin, may work to increase collision between reactants and attract pyruvic acid to the chromophore. Cy3soph5glu had no pyranoanthocyanin formation, confirming the necessity of a hydroxyl group on the C5 site. A decrease in chroma and increase in lightness were observed for all treatment solutions, thought to be the result of degradation; however, greater pyranoanthocyanin yield enhanced color stability (smaller ΔE values). The colorimetric and spectra data derived from HPLC peaks revealed pyranoanthocyanins to have a ˜20° increase in hue angles and hypsochromic shift compared to the anthocyanin precursor. Glycosylation structural conformation was found to be a critical parameter in pyranoanthocyanin formation and must be considered in order to best optimize production of these pigments.

All publications, including patents and non-patent literature, referred to in this specification are expressly incorporated by reference herein. Citation of the any of the documents recited herein is not intended as an admission that any of the foregoing is pertinent prior art. All statements as to the date or representation as to the contents of these documents is based on the information available to the applicant and does not constitute any admission as to the correctness of the dates or contents of these documents.

While the invention has been described with reference to various and preferred embodiments, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof.

Therefore, it is intended that the invention not be limited to the particular embodiment disclosed herein contemplated for carrying out this invention, but that the invention will include all embodiments falling within the scope of the claims.

What is claimed is:

1. A chromophore comprising a compound formed by interaction of ascorbic acid (AA) and a pyranoanthocyanin (PACN) compound at at least one of the A, B, or D ring of the PACN compound.

2. The chromophore of claim 1, wherein the PACN compound is formed by heterocyclic addition of C4 and 5-OH of an anthocyanin with a polar carboxyl-containing compound.

3. The chromophore of claim 2, wherein the anthocyanin is extracted from one or more of: chokeberries, blackberries, black carrots, grapes, red cabbage, mulberries, wines, red onions, or strawberries.

4. The chromophore of claim 2, wherein the anthocyanin has Formula I: 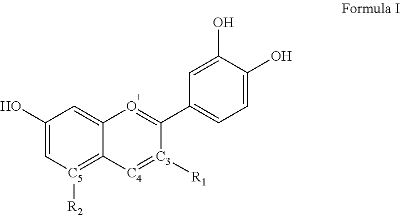
wherein:
R₁ is selected from the group consisting of arabinose, galactose, glucose, xylosyl(1→2)galactoside, glucosyl(1→2)glucoside, rhamnosyl(1→6)glucoside, glucosyl(1→6)galactoside, and xylosyl(1→2)glucosyl(1→6)galactoside; and
R₂ is OH.

5. The chromophore of claim 2, wherein the anthocyanin comprises a sugar with a 1→6 glycosyl linkage.

6. The chromophore of claim 1, wherein the λₘₐₓ of the chromophore is different from the λₘₐₓ of the PACN compound.

7. The chromophore of claim 1, wherein the chromophore is resistant to bleaching.

8. A method of preparing a pyranoanthocyanin, the method comprising reacting an anthocyanin with a polar carboxyl-containing compound to achieve heterocyclic addition of the polar carboxyl-containing compound with the C4 and 5-OH of the anthocyanin and produce a pyranoanthocyanin.

9. The method of claim 8, wherein the polar carboxyl-containing compound comprises pyruvic acid, acetaldehyde, or a catechin.

10. The method of claim 8, wherein the anthocyanin has Formula I: 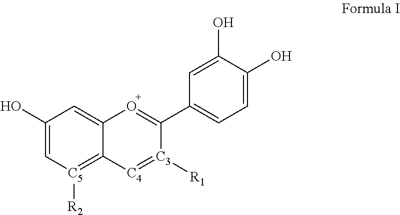
wherein:
R₁ is selected from the group consisting of arabinose, galactose, glucose, xylosyl(1→2)galactoside, glucosyl(1→2)glucoside, rhamnosyl(1→6)glucoside, glucosyl(1→6)galactoside, and xylosyl(1→2)glucosyl(1→6)galactoside; and
R₂ is OH.

11. The method of claim 8, wherein the anthocyanin has the following structural formula Ia:

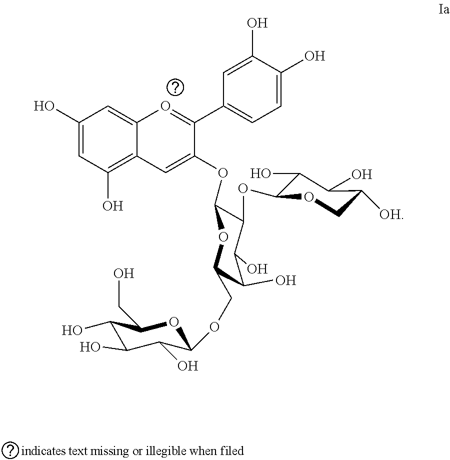

12. The method of claim 8, wherein the anthocyanin has the following structural formula Ib:

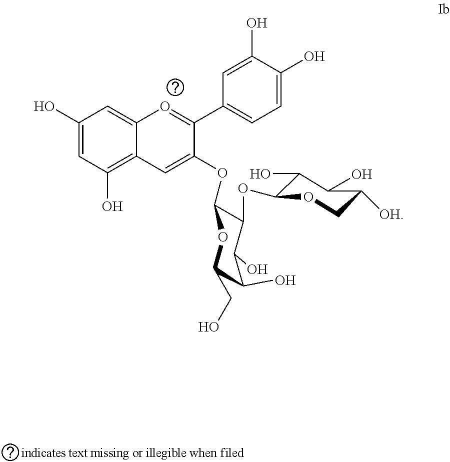

13. The method of claim 8, wherein the anthocyanin has the following structural formula Ic:

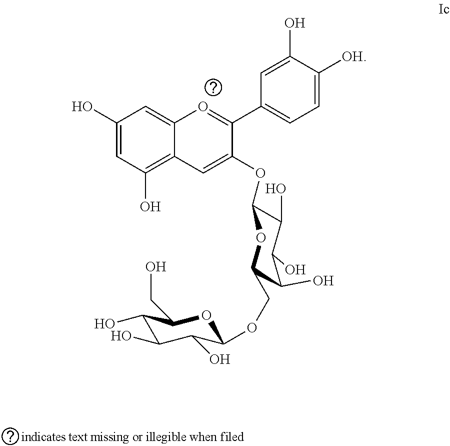

14. The method of claim 8, wherein the anthocyanin has the following structural formula Id:

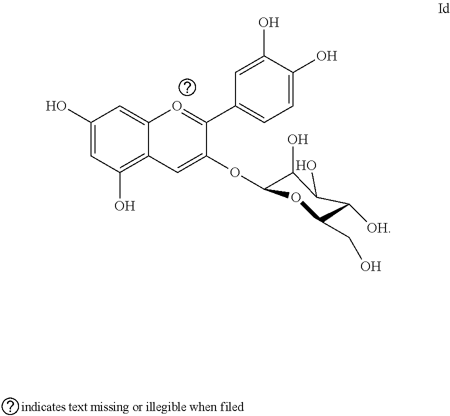

15. The method of claim 8, wherein the anthocyanin has the following structural formula Ie:

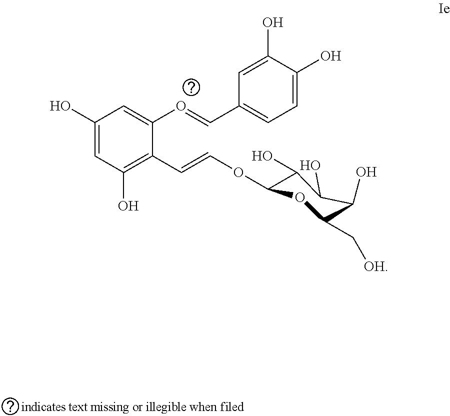

16. The method of claim 8, wherein the anthocyanin comprise one or more of a cyanidin, a pelargonidin, or a malvidin.

17. The method of claim 8, wherein the anthocyanin is extracted from one or more of: chokeberries, blackberries, black carrot, grapes, aged wines, red cabbage, mulberries, red onions, or strawberries.

18. The method of claim 17, comprising washing chokeberry powder with acidified water to remove sugars and acids, washing the acidified water with ethyl acetate to remove non-polar phenolics, recovering pigments with acidified methanol, removing solvent to purify a chokeberry extract, and reacting the purified chokeberry extract with pyruvic acid.

19. The method of claim 8, wherein the pyranoanthocyanin comprises one or more of:
5-carboxypyranomalvidin-3-glucoside,
Pyranomalvidin-3-glucoside,
Carboxypyranopelargonidin-3-glucoside,
3-O-β-glucopyranoside and 3-O-(6″-O-malonyl-β-glucopyranoside),
5-carboxypyranocyanidin-3-glucoside,
5-carboxypyranocyanidin-3-galactoside,
5-carboxypyranocyanidin-3-(glucosyl)galactoside,
5-carboxypyranocyanidin-3-(xylosyl)galactoside, or
5-carboxypyranocyanidin-3-xylosyl(glucosyl)galactoside

20. A natural colorant composition comprising a pyranoanthocyanin formed by the method of claim 8, wherein the natural colorant composition exhibits color stability for greater than about 14 days.

21. A composition comprising Formula II: 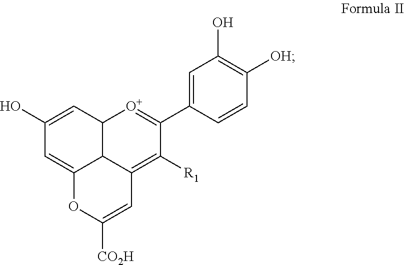
wherein R₁ is selected from the group consisting of xylosyl(1→2)galactoside, glucosyl(1→2)glucoside, rhamnosyl(1→6)glucoside, glucosyl(1→6)galactoside, and xylosyl(1→2)glucosyl(1→6)galactoside;
and salts, stereoisomers, racemates, hydrates, and polymorphs thereof.
